(19) United States
(12) Patent Application Publication
(10) Pub. No.: US 2017/0280306 A1
(43) Pub. Date: Sep. 28, 2017

(54) System for Inter-Communication Between Integrated Digital Enhanced Network Systems and Push-To-Talk-Over-Cellular Systems

(71) Applicant: Kodiak Networks Inc., Plano, TX (US)

(72) Inventors: Krishnakant M. Patel, Richardson, TX (US); Brahmananda R. Vempati, Dallas, TX (US); Ramu Kandula, Plano, TX (US); Harisha M. Negalaguli, Richardson, TX (US)

(21) Appl. No.: 15/618,845

(22) Filed: Jun. 9, 2017

Related U.S. Application Data
(63) Continuation of application No. PCT/US2015/064819, filed on Dec. 9, 2015.
(60) Provisional application No. 62/090,770, filed on Dec. 11, 2014.

(51) Int. Cl. H04W 4/10; H04W 76/00

(52) U.S. Cl. CPC H04W 4/10; H04W 76/005; H04W 88/16

(57) ABSTRACT

A network-to-network interface (NNI) gateway system for inter-communication between a Push-to-talk-over-Cellular (POC) system in a first wireless network and an Integrated Digital Enhanced Network (iDEN) system in a second wireless network. The POC system performs a POC call session for POC mobile units in the first wireless network. The iDEN system performs a Push-to-Talk (PTT) call session for iDEN subscriber units in the second wireless network. The gateway system bridges the iDEN system to the POC system, such that the POC system is exposed to the iDEN system as an emulated iDEN system, the iDEN system is exposed to the POC system as an emulated POC system, and calls are placed across the first and second wireless networks between the POC mobile units and iDEN subscriber units.

### CROSS-REFERENCE TO RELATED APPLICATIONS

This application is a continuation of P.C.T. International Application Serial Number PCT/US2015/064819, filed on Dec. 9, 2015 which claims the benefit under 35 U.S.C. Section 119(e) of the following co-pending and commonly-assigned patent application: U.S. Provisional Application Ser. No. 62/090,770, filed Dec. 11, 2014, by Krishnakant M. Patel and Brahmananda R. Vempati, entitled “METHOD FOR INTERWORKING KODIAK POC AND NEXTEL IDEN,” which applications are incorporated by reference herein.

This application is related to the following commonly-assigned patent applications: U.S. Utility application Ser. No. 10/515,556, filed Nov. 23, 2004, by Gorachand Kundu, Ravi Ayyasamy and Krishnakant Patel, entitled “DISPATCH SERVICE ARCHITECTURE FRAMEWORK,” now U.S. Pat. No. 7,787,896, issued Aug. 31, 2010, which application claims the benefit under 35 U.S.C. Section 35 of P.C.T. International Application Serial Number PCT/US03/16386, which application claims the benefit under 35 U.S.C. Section 119(e) of U.S. Provisional Application Ser. Nos. 60/382,981, 60/383,179 and 60/407,168; U.S. Utility application Ser. No. 10/564,903, filed Jan. 17, 2006, by F. Craig Farrill, Bruce D. Lawler and Krishnakant M. Patel, entitled “PREMIUM VOICE SERVICES FOR WIRELESS COMMUNICATIONS SYSTEMS,” which application claims the benefit under 35 U.S.C. Section 365 of P.C.T. International Application Serial Number PCT/US04/23038, which application claims the benefit under 35 U.S.C. Section 119(e) of U.S. Provisional Application Ser. Nos. 60/488,638, 60/492,650 and 60/576,094 and which application is a continuation-in-part and claims the benefit under 35 U.S.C. Sections 119, 120 and/or 365 of P.C.T. International Application Serial Number PCT/US03/16386; U.S. Utility application Ser. No. 11/126,587, filed May 11, 2005, by Ravi Ayyasamy and Krishnakant M. Patel, entitled “ARCHITECTURE, CLIENT SPECIFICATION AND APPLICATION PROGRAMMING INTERFACE (API) FOR SUPPORTING ADVANCED VOICE SERVICES (AVS) INCLUDING PUSH TO TALK ON WIRELESS HANDSETS AND NETWORKS,” now U.S. Pat. No. 7,738,892, issued Jun. 15, 2010, which application claims the benefit under 35 U.S.C. Section 119(e) of U.S. Provisional Application Ser. Nos. 60/569,953 and 60/579,309, and which application is a continuation-in-part and claims the benefit under 35 U.S.C. Sections 119, 120 and/or 365 of U.S. Utility application Ser. No. 10/515,556 and P.C.T. International Application Serial Number PCT/US04/23038; U.S. Utility application Ser. No. 11/129,268, filed May 13, 2005, by Krishnakant M. Patel, Gorachand Kundu, Ravi Ayyasamy and Basem Ardah, entitled “ROAMING GATEWAY FOR SUPPORT OF ADVANCED VOICE SERVICES WHILE ROAMING IN WIRELESS COMMUNICATIONS SYSTEMS,” now U.S. Pat. No. 7,403,775, issued Jul. 22, 2008, which application claims the benefit under 35 U.S.C. Section 119(e) of U.S. Provisional Application Ser. No. 60/571,075 and which application is a continuation-in-part and claims the benefit under 35 U.S.C. Sections 119, 120 and/or 365 of U.S. Utility application Ser. No. 10/515,556 and P.C.T. International Application Serial Number PCT/US04/23038; U.S. Utility application Ser. No. 11/134,883, filed May 23, 2005, by Krishnakant Patel, Vyankatesh V. Shanbhag, Ravi Ayyasamy, Stephen R. Horton and Shan-Jen Chiou, entitled “ADVANCED VOICE SERVICES ARCHITECTURE FRAMEWORK,” now U.S. Pat. No. 7,764,950, issued Jul. 27, 2010, which application claims the benefit under 35 U.S.C. Section 119(e) of U.S. Provisional Application Ser. Nos. 60/573,059 and 60/576,092, and which application is a continuation-in-part and claims the benefit under 35 U.S.C. Sections 119, 120 and/or 365 of U.S. Utility application Ser. No. 10/515,556, P.C.T. International Application Serial Number PCT/US04/23038, U.S. Utility application Ser. No. 11/126,587, and U.S. Utility application Ser. No. 11/129,268; U.S. Utility application Ser. No. 11/136,233, filed May 24, 2005, by Krishnakant M. Patel, Vyankatesh Vasant Shanbhag, and Anand Narayanan, entitled “SUBSCRIBER IDENTITY MODULE (SIM) ENABLING ADVANCED VOICE SERVICES (AVS) INCLUDING PUSH-TO-TALK, PUSH-TO-CONFERENCE AND PUSH-TO-MESSAGE ON WIRELESS HANDSETS AND NETWORKS,” now U.S. Pat. No. 7,738,896, issued Jun. 15, 2010, which application claims the benefit under 35 U.S.C. Section 119(e) of U.S. Provisional Application Ser. No. 60/573,780, and which application is a continuation-in-part and claims the benefit under 35 U.S.C. Sections 119, 120 and/or 365 of U.S. Utility application Ser. No. 10/515,556, P.C.T. International Application Serial Number PCT/US04/23038, U.S. Utility application Ser. No. 11/126,587, and U.S. Utility application Ser. No. 11/134,883; U.S. Utility application Ser. No. 11/158,527, filed Jun. 22, 2005, by F. Craig Farrill, entitled “PRESS-TO-CONNECT FOR WIRELESS COMMUNICATIONS SYSTEMS,” now U.S. Pat. No. 7,529,557, issued May 5, 2009, which application claims the benefit under 35 U.S.C. Section 119(e) of U.S. Provisional Application Ser. No. 60/581,954, and which application is a continuation-in-part and claims the benefit under 35 U.S.C. Sections 119, 120 and/or 365 of U.S. Utility application Ser. No. 10/515,556 and P.C.T. International Application Serial Number PCT/US04/23038; U.S. Utility application Ser. No. 11/183,516, filed Jul. 18, 2005, by Deepankar Biswaas, entitled “VIRTUAL PUSH TO TALK (PTT) AND PUSH TO SHARE (PTS) FOR WIRELESS COMMUNICATIONS SYSTEMS,” which application claims the benefit under 35 U.S.C. Section 119(e) of U.S. Provisional Application Ser. No. 60/588,464; U.S. Utility application Ser. No. 11/356,775, filed Feb. 17, 2006, by Krishnakant M. Patel, Bruce D. Lawler, Giridhar K. Boray, and Brahmananda R. Vempati, entitled “ENHANCED FEATURES IN AN ADVANCED VOICE SERVICES (AVS) FRAMEWORK FOR WIRELESS COMMUNICATIONS SYSTEMS,” now U.S. Pat. No. 7,813,722, issued Oct. 12, 2010, which application claims the benefit under 35 U.S.C. Section 119(e) of U.S. Provisional Application Ser. No. 60/654,271; P.C.T. International Application Serial Number PCT/US2006/011628, filed Mar. 30, 2006, by Krishnakant M. Patel, Gorachand Kundu, Sameer Dharangaonkar, Giridhar K. Boray, and Deepankar Biswas, entitled “TECHNIQUE FOR IMPLEMENTING ADVANCED VOICE SERVICES USING AN UNSTRUCTURED SUPPLEMENTARY SERVICE DATA (USSD) INTERFACE,” which application claims the benefit under 35 U.S.C. Section 119(e) of U.S. Provisional Application Ser. No. 60/666,424; U.S. Utility application Ser. No. 11/462,332, filed Aug. 3, 2006, by Deepankar Biswas, Krishnakant M. Patel, Giridhar K. Boray, and Gorachand Kundu, entitled “ARCHITECTURE AND IMPLEMENTATION OF CLOSED USER GROUP AND LIMITING MOBILITY IN WIRELESS NETWORKS,” now U.S. Pat. No. 7,689,238, issued Mar. 30, 2010, which application claims the benefit under 35 U.S.C. Section 119(e) of U.S. Provisional Application Ser. No. 60/705,115; U.S. Utility application Ser. No. 11/463,186, filed Aug. 8, 2006, by Ravi Ayyasamy and Krishnakant M. Patel, entitled “ADVANCED VOICE SERVICES CLIENT FOR BREW PLATFORM,” now U.S. Pat. No. 8,036,692, issued Oct. 11, 2011, which application claims the benefit under 35 U.S.C. Section 119(e) of U.S. Provisional Application Ser. No. 60/706,265; U.S. Utility application Ser. No. 11/567,098, filed Dec. 5, 2006, by Ravi Ayyasamy, Bruce D. Lawler, Krishnakant M. Patel, Vyankatesh V. Shanbhag, Brahmananda R. Vempati, and Ravi Shankar Kumar, entitled “INSTANT MESSAGING INTERWORKING IN AN ADVANCED VOICE SERVICES (AVS) FRAMEWORK FOR WIRELESS COMMUNICATIONS SYSTEMS,” which application claims the benefit under 35 U.S.C. Section 119(e) of U.S. Provisional Application Ser. No. 60/742,250; U.S. Utility application Ser. No. 11/740,805, filed Apr. 26, 2007, by Krishnakant M. Patel, Giridhar K. Boray, Ravi Ayyasamy, and Gorachand Kundu, entitled “ADVANCED FEATURES ON A REAL-TIME EXCHANGE SYSTEM,” now U.S. Pat. No. 7,853,279, issued Dec. 14, 2010, which application claims the benefit under 35 U.S.C. Section 119(e) of U.S. Provisional Application Ser. No. 60/795,090; U.S. Utility application Ser. No. 11/891,127, filed Aug. 9, 2007, by Krishnakant M. Patel, Deepankar Biswas, Sameer P. Dharangaonkar and Terakanambi Nanjanayaka Raja, entitled “EMERGENCY GROUP CALLING ACROSS MULTIPLE WIRELESS NETWORKS,” which application claims the benefit under 35 U.S.C. Section 119(e) of U.S. Provisional Application Ser. No. 60/836,521; U.S. Utility application Ser. No. 12/259,102, filed on Oct. 27, 2008, by Krishnakant M. Patel, Gorachand Kundu, and Ravi Ayyasamy, entitled “CONNECTED PORTFOLIO SERVICES FOR A WIRELESS COMMUNICATIONS NETWORK,” which application claims the benefit under 35 U.S.C. Section 119(e) of U.S. Provisional Application Ser. Nos. 60/982,650 and 61/023,042; U.S. Utility application Ser. No. 12/359,861, filed on Jan. 26, 2009, by Bruce D. Lawler, Krishnakant M. Patel, Ravi Ayyasamy, Harisha Mahabaleshwara Negalaguli, Binu Kaiparambil, Shiva Cheedella, Brahmananda R. Vempati, Ravi Shankar Kumar, and Avrind Shanbhag, entitled “CONVERGED MOBILE-WEB COMMUNICATIONS SOLUTION,” now U.S. Pat. No. 8,676,189, issued Mar. 18, 2014, which application claims the benefit under 35 U.S.C. Section 119(e) of U.S. Provisional Application Ser. No. 61/023,332; U.S. Utility application Ser. No. 12/582,601, filed Oct. 20, 2009, by Krishnakant M. Patel, Ravi Ayyasamy, Gorachand Kundu, Basem A. Ardah, Anand Narayanan, Brahmananda R. Vempati, and Pratap Chandana, entitled “HYBRID PUSH-TO-TALK FOR MOBILE PHONE NETWORKS,” now U.S. Pat. No. 8,958,348, issued Feb. 17, 2015, which application claims the benefit under 35 U.S.C. Section 119(e) of U.S. Provisional Application Ser. No. 61/106,689; U.S. Utility application Ser. No. 12/781,566, filed on May 17, 2010, by Bruce D. Lawler, Krishnakant M. Patel, Ravi Ayyasamy, Harisha Mahabaleshwara Negalaguli, Binu Kaiparambil, Shiva K. K. Cheedella, Brahmananda R. Vempati, and Ravi Shankar Kumar, entitled “CONVERGED MOBILE-WEB COMMUNICATIONS SOLUTION,”, now U.S. Pat. No. 8,670,760, issued Mar. 11, 2014, which application is a continuation-in-part and claims the benefit under 35 U.S.C. Sections 119, 120 and/or 365 of U.S. Utility application Ser. No. 12/582,601; U.S. Utility application Ser. No. 12/750,175, filed on Mar. 30, 2010, by Bruce D. Lawler, Krishnakant M. Patel, Ravi Ayyasamy, Harisha Mahabaleshwara Negalaguli, Basem A. Ardah, Gorachund Kundu, Ramu Kandula, Brahmananda R. Vempati, Ravi Shankar Kumar, Chetal M. Patel, and Shiva K. K. Cheedella, entitled “ENHANCED GROUP CALLING FEATURES FOR CONNECTED PORTFOLIO SERVICES IN A WIRELESS COMMUNICATIONS NETWORK,” now U.S. Pat. No. 8,498,660, issued Jul. 30, 2013, which application claims the benefit under 35 U.S.C. Section 119(e) of U.S. Provisional Application Ser. Nos. 61/164,754 and 61/172,129; U.S. Utility application Ser. No. 12/961,419, filed Dec. 6, 2010, by Ravi Ayyasamy, Bruce D. Lawler, Brahmananda R. Vempati, Gorachand Kundu and Krishnakant M. Patel, entitled “COMMUNITY GROUP CLIENT AND COMMUNITY AUTO DISCOVERY SOLUTIONS IN A WIRELESS COMMUNICATIONS NETWORK,” which application claims the benefit under 35 U.S.C. Section 119(e) of U.S. Provisional Application Ser. No. 61/266,896; U.S. Utility application Ser. No. 13/039,635, filed on Mar. 3, 2011, by Narasimha Raju Nagubhai, Ravi Shankar Kumar, Krishnakant M. Patel, and Ravi Ayyasamy, entitled “PREPAID BILLING SOLUTIONS FOR PUSH-TO-TALK IN A WIRELESS COMMUNICATIONS NETWORK,”, now U.S. Pat. No. 8,369,829, issued Feb. 5, 2013, which application claims the benefit under 35 U.S.C. Section 119(e) of U.S. Provisional Application Ser. No. 61/310,245; U.S. Utility application Ser. No. 13/093,542, filed Apr. 25, 2011, by Brahmananda R. Vempati, Krishnakant M. Patel, Pratap Chandana, Anand Narayanan, Ravi Ayyasamy, Bruce D. Lawler, Basem A. Ardah, Ramu Kandula, Gorachand Kundu, Ravi Shankar Kumar, and Bibhudatta Biswal, and entitled “PREDICTIVE WAKEUP FOR PUSH-TO-TALK-OVER-CELLULAR (POC) CALL SETUP OPTIMIZATIONS,” now U.S. Pat. No. 8,478,261, issued Jul. 2, 2013, which application claims the benefit under 35 U.S.C. Section 119(e) of U.S. Provisional Application Ser. No. 61/347,217; U.S. Utility application Ser. No. 13/710,683, filed Dec. 11, 2012, by Ravi Ayyasamy, Gorachand Kundu, Krishnakant M. Patel, Brahmananda R. Vempati, Harisha M. Negalaguli, Shiva K. K. Cheedella, Basem A. Ardah, Ravi Shankar Kumar, Ramu Kandula, Arun Velayudhan, Shibu Narendranathan, Bharatram Setti, Anand Narayanan, and Pratap Chandana, entitled “PUSH-TO-TALK-OVER-CELLULAR (POC),” which application claims the benefit under 35 U.S.C. Section 119(e) of U.S. Provisional Application Ser. No. 61/570,694; U.S. Utility application Ser. No. 13/917,561, filed Jun. 13, 2013, by Krishnakant M. Patel, Brahmananda R. Vempati, Anand Narayanan, Gregory J. Morton, and Ravi Ayyasamy, entitled “RUGGEDIZED CASE OR SLEEVE FOR PROVIDING PUSH-TO-TALK (PTT) FUNCTIONS,” which application claims the benefit under 35 U.S.C. Section 119(e) of U.S. Provisional Application Ser. No. 61/659,292; U.S. Provisional Application Ser. No. 61/682,524; and U.S. Provisional Application Ser. No. 61/705,748; U.S. Utility application Ser. No. 13/757,520, filed Feb. 1, 2013, by Krishnakant M. Patel, Harisha Mahabaleshwara Negalaguli, Brahmananda R. Vempati, Shiva Koteshwara Kiran Cheedella, Arun Velayudhan, Raajeev Kuppa, Gorachand Kundu, Ravi Ganesh Ramamoorthy, Ramu Kandula, Ravi Ayyasamy, and Ravi Shankar Kumar, entitled “WiFi INTERWORKING SOLUTIONS FOR PUSH-TO-TALK-OVER-CELLULAR (POC),” now U.S. Pat. No. 9,088,876, issued Jul. 21, 2015, which application claims the benefit under 35 U.S.C. Section 119(e) of U.S. Provisional Application Ser. No. 61/593,485; U.S. Utility application Ser. No. 14/093,240, filed Nov. 29, 2013, by Gorachand Kundu, Krishnakant M. Patel, Harisha Mahabaleshwara Negalaguli, Ramu Kandula, and Ravi Ayyasamy, entitled “METHOD AND FRAMEWORK TO DETECT SERVICE USERS IN INSUFFICIENT WIRELESS RADIO COVERAGE NETWORK AND IMPROVE SERVICE DELIVERY EXPERIENCE BY GUARANTEED PRESENCE,” now U.S. Pat. No. 9,137,646, issued Sep. 15, 2015, which application claims the benefit under 35 U.S.C. Section 119(e) of U.S. Provisional Application Ser. No. 61/730,856; P.C.T. International Application Serial Number PCT/US2014/036414, filed May 1, 2014, by Krishnakant M. Patel, Harisha Mahabaleshwara Negalaguli, Arun Velayudhan, Ramu Kandula, Syed Nazir Khadar, Shiva Koteshwara Kiran Cheedella, and Subramanyam Narasimha Prashanth, entitled “VOICE-OVER-IP (VOIP) DENIAL OF SERVICE (DOS) PROTECTION MECHANISMS FROM ATTACK,” which application claims the benefit under 35 U.S.C. Section 119(e) of U.S. Provisional Application Ser. No. 61/818,109; and U.S. Provisional Application Ser. No. 61/821,975; U.S. Utility application Ser. No. 14/286,427, filed May 23, 2014, by Krishnakant M. Patel, Ravi Ayyasamy and Brahmananda R. Vempati, entitled “METHOD TO ACHIEVE A FULLY ACKNOWLEDGED MODE COMMUNICATION IN PUSH-TO-TALK OVER CELLULAR (POC),” which application claims the benefit under 35 U.S.C. Section 119(e) of U.S. Provisional Application Ser. No. 61/826,895; P.C.T. International Application Serial Number PCT/US2014/047863, filed on Jul. 23, 2014, by Gorachand Kundu, Giridhar K. Boray, Brahmananda R. Vempati, Krishnakant M. Patel, Ravi Ayyasamy, and Harisha M. Negalaguli, entitled “EFFECTIVE PRESENCE FOR PUSH-TO-TALK-OVER-CELLULAR (POC) NETWORKS,” which application claims the benefit under 35 U.S.C. Section 119(e) of U.S. Provisional Application Ser. No. 61/857,363; and U.S. Provisional Application Ser. No. 61/944,168; P.C.T. International Application Serial Number PCT/US15/10617, filed Jan. 8, 2015, by Krishnakant M. Patel, Brahmananda R. Vempati, and Harisha Mahabaleshwara Negalaguli, entitled “OPTIMIZED METHODS FOR LARGE GROUP CALLING USING UNICAST AND MULTICAST TRANSPORT BEARER FOR PUSH-TO-TALK-OVER-CELLULAR (POC),” which application claims the benefit under 35 U.S.C. Section 119(e) of U.S. Provisional Application Ser. No. 61/924,897; U.S. Utility application Ser. No. 14/639,794, filed Mar. 5, 2015, by Krishnakant M. Patel, Brahmananda R. Vempati, Ravi Ayyasamy, and Bibhudatta Biswal, entitled “PUSH-TO-TALK-OVER-CELLULAR (POC) SERVICE IN HETEROGENEOUS NETWORKS (HETNETS) AND MULTIMODE SMALL CELL ENVIRONMENTS,” which application claims the benefit under 35 U.S.C. Section 119(e) of U.S. Provisional Application Ser. No. 61/948,429; P.C.T. International Application Serial Number PCT/US2014/047886, filed on Jul. 23, 2014, by Gorachand Kundu, Giridhar K. Boray, Brahmananda R. Vempati, Krishnakant M. Patel, Ravi Ayyasamy, Harisha Mahabaleshwara Negalaguli, and Ramu Kandula, entitled “RADIO ACCESS NETWORK (RAN) AWARE SERVICE DELIVERY FOR PUSH-TO-TALK-OVER-CELLULAR (POC) NETWORKS,” which application is a continuation-in-part under 35 U.S.C. Section 120 of P.C.T. International Application Serial Number PCT/US2014/047863; P.C.T. International Application Serial Number PCT/US2015/45951, filed on Aug. 19, 2015, by Krishnakant M. Patel, Brahmananda R. Vempati, and Harisha Mahabaleshwara Negalaguli, entitled “RELAY-MODE AND DIRECT-MODE OPERATIONS FOR PUSH-TO-TALK-OVER-CELLULAR (POC) USING WIFI TECHNOLOGIES,” which application claims the benefit under 35 U.S.C. Section 119(e) of U.S. Provisional Application Ser. No. 62/039,272; P.C.T. International Application Serial Number PCT/US2015/56712, filed on Oct. 21, 2015, by Krishnakant M. Patel, Ramu Kandula, Brahmananda R. Vempati, Pravat Kumar Singh, and Harisha Mahabaleshwara Negalaguli, entitled “SYSTEM FOR INTER-COMMUNICATION BETWEEN LAND MOBILE RADIO AND PUSH-TO-TALK-OVER-CELLULAR SYSTEMS,” which application claims the benefit under 35 U.S.C. Section 119(e) of U.S. Provisional Application Ser. No. 62/066,533; P.C.T. International Application Serial Number PCT/US2015/058088, filed on Oct. 29, 2015, by Krishnakant M. Patel, Bibhudatta Biswal, Harisha Mahabaleshwara Negalaguli, Ramu Kandula, Brahmananda R. Vempati, Ravi Ayyasamy, Gorachand Kundu, Ravi Ganesh Ramamoorthy and Rajendra Kumar Anthony, entitled “METHODS TO LEVERAGE WEB REAL-TIME COMMUNICATION FOR IMPLEMENTING PUSH-TO-TALK SOLUTIONS,” which application claims the benefit under 35 U.S.C. Section 119(e) of U.S. Provisional Application Ser. Nos. 62/072,135 and 62/117,575; P.C.T. International Application Serial Number PCT/US2015/058804, filed on Nov. 3, 2015, by Harisha Mahabaleshwara Negalaguli, Krishnakant M. Patel, Brahmananda R. Vempati, and Ramu Kandula, entitled “METHOD FOR PROVIDING DYNAMIC QUALITY OF SERVICE FOR PUSH-TO-TALK SERVICE,” which application claims the benefit under 35 U.S.C. Section 119(e) of U.S. Provisional Application Ser. No. 62/074,386; P.C.T. International Application Serial Number PCT/US2015/058821, filed on Nov. 3, 2015, by Krishnakant M. Patel, Harisha Mahabaleshwara Negalaguli, Brahmananda R. Vempati, and Ramu Kandula, entitled “ARCHITECTURE FRAMEWORK TO REALIZE PUSH-TO-X SERVICES USING CLOUD-BASED STORAGE SERVICES,” which application claims the benefit under 35 U.S.C. Section 119(e) of U.S. Provisional Application Ser. No. 62/074,391; P.C.T. International Application Serial Number PCT/US2015/058880, filed on Nov. 3, 2015, by Krishnakant M. Patel, Ramu Kandula, Brahmananda R. Vempati, Harisha Mahabaleshwara Negalaguli, and Bharat Ram Setti Nagaswamy Srinivasan, entitled “METHOD FOR MULTIPLEXING MEDIA STREAMS TO OPTIMIZE NETWORK RESOURCE USAGE FOR PUSH-TO-TALK-OVER-CELLULAR (POC) SERVICE,” which application claims the benefit under 35 U.S.C. Section 119(e) of U.S. Provisional Application Ser. No. 62/074,472 and U.S. Provisional Application Ser. No. 62/111,409; all of which applications are incorporated by reference herein.

### BACKGROUND

### 1. Field of the Invention

Various embodiments relate in general to advanced voice services in wireless communications networks, and more specifically, to a system and method for inter-communication between Integrated Digital Enhanced Network (iDEN) and Push-to-talk-over-Cellular (POC) systems.

### 2. Description of Related Art

Advanced voice services (AVS), also known as Advanced Group Services (AGS), such as two-way half-duplex voice calls within a group, also known as Push-to-talk-over-Cellular (POC), Push-to-Talk (PTT), or Press-to-Talk (P2T), as well as other AVS functions, such as Push-to-Conference (P2C) or Instant Conferencing (IC), Push-to-Message (P2M), etc., are described in the co-pending and commonly-assigned patent applications cross-referenced above and incorporated by reference herein. These AVS functions have enormous revenue earnings potential for wireless communications systems, such as cellular networks, wireless data networks and IP networks.

One approach to PTT is based on packet or voice-over-IP (VoIP) technologies. This approach capitalizes on the “bursty” nature of PTT conversations and makes network resources available only during talk bursts and hence is highly efficient from the point of view of network and spectral resources. This approach promises compliance with newer and emerging packet-based standards, such as GPRS (General Packet Radio Service), UMTS (Universal Mobile Telecommunications System), 3G/4G/LTE (3rd Generation/4th Generation/Long Term Evolution), etc.

Nonetheless, there is a need in the art for improvements to the methods and systems for delivering the advanced voice services, such as PTT, that comply with both existing and emerging wireless standards and yet provide superior user experiences. For example, many existing implementations of PTT do not support connections to different wireless networks. Various embodiments, on the other hand, satisfy the need for supporting connections to different wireless networks.

### SUMMARY OF THE INVENTION

To overcome the limitations in the prior art described above, and to overcome other limitations that will become apparent upon reading and understanding the present specification, various embodiments disclose a system and method for providing advanced voice services in a plurality of wireless networks. A gateway system is provided for inter-communicating between a Push-to-Talk-over-Cellular (POC) system in a first wireless network and an Integrated Digital Enhanced Network (iDEN) system in a second wireless network. The POC system performs a POC call session for one or more POC mobile units in the first wireless network, wherein the POC call session comprises an instant two-way half-duplex voice call within a group of the POC mobile units. The iDEN system performs a Push-to-Talk (PTT) call session for one or more iDEN subscriber units in the second wireless network, wherein the PTT call session comprises an instant two-way half-duplex voice call within a group of the iDEN subscriber units. The gateway system bridges the iDEN system to the POC system, such that the POC system is exposed to the iDEN system as an emulated iDEN system, the iDEN system is exposed to the POC system as an emulated POC system, and calls are placed across the first and second wireless networks between the POC mobile units and iDEN subscriber units.

The gateway system creates and manages identifier mappings in order to make the POC mobile units and their groups addressable by the iDEN system, and to make the iDEN subscriber units and their groups addressable by the POC system.

The gateway system exposes the iDEN subscriber units and their groups to the POC system using mobile unit and group identifiers of the first wireless network. An iDEN subscriber unit that is exposed to the POC system is assigned a mobile directory number (MDN) in order to make the iDEN subscriber unit addressable by the POC system. An iDEN subscriber unit that is exposed to the POC system is also addressable by a POC mobile unit in the POC system using a Universal Fleet Member Identifier (UFMI).

The gateway system exposes the POC mobile units and their groups to the iDEN system using subscriber unit and group identifiers of the second wireless network. A POC mobile unit that is exposed to the iDEN system is assigned a Universal Fleet Member Identifier (UFMI) in order to make the POC mobile unit addressable by the iDEN system.

In one embodiment, an iDEN Gateway (iGW) is used to interface the gateway system with the iDEN system. The gateway system maps an interface with the POC system to the iGW and performs any protocol conversion necessary for the iGW. The gateway system performs as an iGW when interfacing with the iDEN system.

In another embodiment, a POC-iDEN Soft Bridge is used to interface the gateway system with the iDEN system, wherein the POC-iDEN Soft Bridge comprises an iDEN User Agent part and a POC User Agent part, which are bound together to interface with the iDEN system. The POC-iDEN Soft Bridge connects to the iDEN system and the gateway system using an Internet Protocol (IP) interface.

In yet another embodiment, a smart donor radio unit is used to interface the gateway system with the iDEN system, wherein the smart donor radio unit is programmatically controlled through an Internet Protocol (IP) based interface. The smart donor radio unit connects to the iDEN system over an air interface and provides the IP based interface to the gateway system.

### BRIEF DESCRIPTION OF THE DRAWINGS

Referring now to the drawings in which like reference numbers represent corresponding parts throughout:

FIG. 1 illustrates the system architecture used in an embodiment.

FIG. 2 is a state diagram that illustrates the operation of a POC or PTT session according to an embodiment.

FIG. 3 illustrates a POC-iDEN interworking architecture using an iDEN Gateway (iGW) interface, according to an embodiment;

FIG. 4 illustrates a POC-iDEN private call through the iGW, according to an embodiment;

FIG. 5 illustrates a POC-iDEN group call through the iGW, according to an embodiment;

FIG. 6 illustrates a private call through the iGW initiated by a POC Client, according to an embodiment;

FIG. 7 illustrates a private call through the iGW initiated by an iDEN Client, according to an embodiment;

FIG. 8 illustrates POC/PTT floor control through the iGW, according to an embodiment;

FIG. 9 illustrates a POC/PTT group call through the iGW, according to an embodiment;

FIG. 10 shows how the iGW intercepts POC/PTT audio transmissions and POC/PTT control signals from one system and relays them to the other system, according to an embodiment;

FIG. 11 illustrates a POC-iDEN interworking architecture using a POC-iDEN Soft Bridge, according to an embodiment;

FIG. 12 shows how the POC-iDEN Soft Bridge assigns an alias Universal Fleet Member Identifier (UFMI) to a POC user, and allows the POC user to become a member of an iDEN fleet, according to an embodiment;

FIG. 13 illustrates a private call through the POC-iDEN Soft Bridge initiated by a POC Client, according to an embodiment;

FIG. 14 shows a simple donor radio solution used for interworking with closed PTT systems, according to an embodiment;

FIG. 15 shows a smart donor radio solution which allows the relationship between the donor device and the actual iDEN subscriber end point to be configured dynamically through a programmatic interface, according to an embodiment;

FIG. 16 illustrates a POC-iDEN interworking architecture using a Smart Donor Radio System, according to an embodiment;

FIG. 17 illustrates a Mobile Directory Number (MDN)-UFMI mapping using the Smart Donor Radio System, according to an embodiment;

FIG. 18 illustrates a private call through a Smart Donor Radio System from a POC Client to an iDEN Client, according to an embodiment;

FIG. 19 illustrates a private call through a Smart Donor Radio System from an iDEN Client to a POC Client, according to an embodiment;

FIG. 20 illustrates a typical floor control exchange sequence through a Smart Donor Radio System during a private call between an iDEN Client and a POC Client, according to an embodiment;

### DETAILED DESCRIPTION OF THE INVENTION

In the following description of the preferred embodiment, reference is made to the accompanying drawings which form a part hereof, and in which is shown by way of illustration the specific embodiment in which the invention may be practiced. It is to be understood that other embodiments may be utilized as structural changes may be made without departing from the scope of the present invention.

### 1 Overview

Embodiments disclose a system for implementing advanced voice services in wireless communications networks that provides a feature-rich server architecture with a flexible client strategy. Specifically, embodiments are directed to a Push-to-talk-over-Cellular (POC) system that inter-communicates with an Integrated Digital Enhanced Network (iDEN) system.

The POC System disclosed herein system is an Open Mobile Alliance (OMA) standards-compliant solution that can be easily deployed, thereby enabling carriers to increase their profits, improve customer retention and attract new customers without costly upgrades to their network infrastructure. This system is built on a proven, reliable all-IP (Internet Protocol) platform. The highly scalable platform is designed to allow simple network planning and growth. Multiple servers can be distributed across operator networks for broad geographic coverage and scalability to serve a large and expanding subscriber base.

### 1.1 Definitions

The following table defines various acronyms, including industry-standard acronyms, that are used in this specification.

| Acronym | Description |
|---|---|
| ATCA | Advanced Telecommunications Computing |
| | Architecture |
| DnD | Do not Disturb |
| DNS | Domain Name Server |
| MBMS/eMBMS | Multimedia Broadcast Multicast Services |
| GPRS | General Packet Radio Service |
| GSM | Global System for Mobile communications |
| GTM | Global Traffic Manager |
| GTP | GPRS Tunneling Protocol |
| HTTP | Hypertext Transport Protocol |
| HTTPS | Secure Hypertext Transport Protocol |
| iDEN | Integrated Digital Enhanced Network |
| IMSI | International Mobile Subscriber Identity |
| IP | Internet Protocol |
| IPA | Instant Personal Alert |
| MBCP | Media Burst Control Protocol |
| MCC | Mobile Country Code |
| MDN | Mobile Directory Number |
| MNC | Mobile Network Code |
| MS-ISDN | Mobile Station International Subscriber |
| | Directory Number |
| NNI | Network-to-network interface |
| OMA | Open Mobile Alliance |
| POC | Push-to-talk-over-Cellular |
| PGW | Packet GateWay |
| PIT | Push-To-Talk |
| RTCP | Realtime Transport Control Protocol |
| RTP | Realtime Transport Protocol |
| SDP | Session Description Protocol |
| SIM | Subscriber Identity Module |
| SIP | Session Initiation Protocol |
| SMMP | Short Message peer-to-peer Protocol |
| SMS | Small Message Service |
| SRTP | Secure Real-time Transport Protocol |
| SSL | Secure Sockets Layer protocol |
| SSRC | Synchronization SouRCe |
| TLS | Transport Layer Security protocol |
| UDP | User Datagram Protocol |
| UFMI | Universal Fleet Member Identifier |
| URI | Uniform Resource Identifier |
| VoIP | Voice-over-IP |
| VPN | Virtual Private Network |
| SGW | Serving GateWay |
| XCAP | XML Configuration Access Protocol |
| XDM | XML Document Management |
| XML | Extensible Mark-up Language |
| 4G/LTE | 4^{th} Generation/Long Term Evolution |

The following table defines various terms, including industry-standard terms, that are used in this specification.

| Term | Description |
|---|---|
| 1-1 POC Session | A feature enabling a POC User to establish a POC Session with another |
| | POC User. |
| Ad Hoc POC Group | A POC Group Session established by a POC User to POC Users listed |
| Session | on the invitation. The list includes POC Users or POC Groups or both. |
| Answer Mode | A POC Client mode of operation for the terminating POC Session |
| | invitation handling. |
| Controlling POC | A function implemented in a POC Server, providing centralized POC |
| Function | Session handling, which includes media distribution, Talk Burst |
| | Control, Media Burst Control, policy enforcement for participation in |
| | the POC Group Sessions, and participant information. |
| Corporate | These subscribers will only receive contacts and groups from a |
| | corporate administrator. That means they cannot create their own |
| | contacts and groups from handset. |
| Corporate Public | These subscribers receive contacts and groups from a corporate |
| | administrator in addition to user-created contacts and groups. |
| Corporate | A user who manages corporate subscribers, their contacts and groups. |
| Administrator | |
| Firewall | A device that acts as a barrier to prevent unauthorized or unwanted |
| | communications between computer networks and external devices. |
| Home POC Server | The POC Server of the POC Service Provider that provides POC service |
| | to the POC User. |
| Instant Personal Alert | A feature in which a POC User sends a SIP based instant message to a |
| | POC User requesting a 1-1 POC Session. |
| Law Enforcement | An organization authorized by a lawful authorization based on a |
| Agency | national law to request interception measures and to receive the |
| | results of telecommunications interceptions. |
| Lawful Interception | The legal authorization, process, and associated technical capabilities |
| | and activities of Law Enforcement Agencies related to the timely |
| | interception of signaling and content of wire, oral, or electronic |
| | communications. |
| Notification | A message sent from the Presence Service to a subscribed watcher |
| | when there is a change in the Presence Information of some presentity |
| | of interest, as recorded in one or more Subscriptions. |
| Participating POC | A function implemented in a POC Server, which provides POC Session |
| Function | handling, which includes policy enforcement for incoming POC |
| | Sessions and relays Talk Burst Control and Media Burst Control |
| | messages between the POC Client and the POC Server performing the |
| | Controlling POC Function. The Participating POC Function may also |
| | relay RTP Media between the POC Client and the POC Server |
| | performing the Controlling POC Function. |
| POC Client | A functional entity that resides on the User Equipment that supports |
| | the POC service. |
| Pre-Arranged POC | A SIP URI identifying a Pre-Arranged POC Group. A Pre-Arranged |
| Group Identity | POC Group Identity is used by the POC Client, e.g., to establish POC |
| | Group Sessions to the Pre-Arranged POC Groups. |
| Pre-Arranged POC | A persistent POC Group. The establishment of a POC Session to a Pre- |
| Group | Arranged POC Group results in the members being invited. |
| Pre-Established | The Pre-Established Session is a SIP Session established between the |
| Session | POC Client and its Home POC Server. The POC Client establishes the |
| | Pre-Established Session prior to making requests for POC Sessions to |
| | other POC Users. To establish a POC Session based on a SIP request |
| | from the POC User, the POC Server conferences other POC Servers or |
| | users to the Pre-Established Session so as to create an end-to-end |
| | connection. |
| Presence Server | A logical entity that receives Presence Information from a multitude of |
| | Presence Sources pertaining to the Presentities it serves and makes |
| | this information available to Watchers according to the rules |
| | associated with those Presentities. |
| Presentity | A logical entity that has Presence Information associated with it. This |
| | Presence Information may be composed from a multitude of Presence |
| | Sources. A Presentity is most commonly a reference for a person, |
| | although it may represent a role such as “help desk” or a resource such |
| | as “conference room #27”. The Presentity is identified by a SIP URI, |
| | and may additionally be identified by a tel URI or a pres URI. |
| Public | These subscribers create and manage their contacts and groups. |
| Serving Server | A set of primary and secondary servers. |
| Subscription | The information kept by the Presence Service about a subscribed |
| | watcher's request to be notified of changes in the Presence |
| | Information of one or more Presentities. |
| Watcher | Any uniquely identifiable entity that requests Presence Information |
| | about a Presentity from the Presence Service. |
| WiFi | A wireless local area network (WLAN). |

### 2 System Architecture

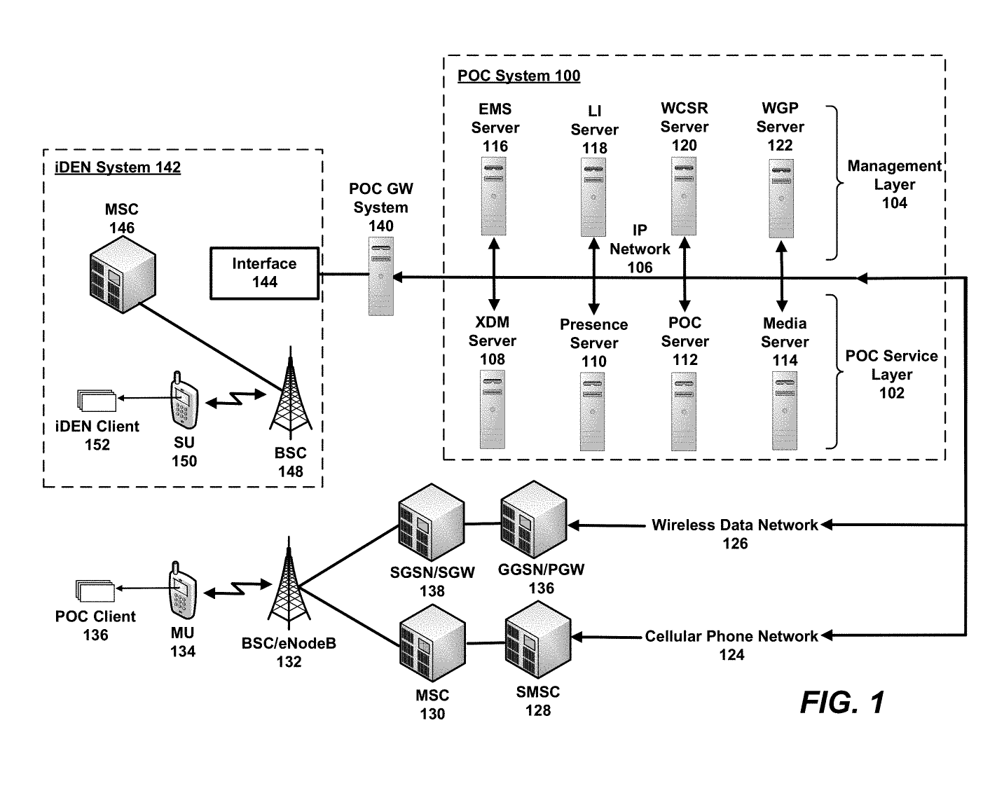

FIG. 1 illustrates the system architecture used in an embodiment. This architecture conforms to the Advanced Telecommunications Computing Architecture (ATCA) standard to support the advanced voice services of an embodiment. ATCA is an open standards-based, high-availability telecommunications platform architecture.

Preferably, the POC System 100 includes one or more POC Service Layers 102 and one or more Management Layers 104, each of which is comprised of one or more servers interconnected by one or more IP networks 106. Specifically, the POC Service Layer 102 includes one or more XML Document Management (XDM) Servers 108, Presence Servers 110, POC Servers 112, and Media Servers 114, while the Management Layer 104 includes one or more Element Management System (EMS) Servers 116, Lawful Intercept (LI) Servers 118, Web Customer Service Representative (WCSR) Servers 120, and Web Group Provisioning (WGP) Servers 122. These various servers are described in more detail below.

The POC Service Layer 102 and Management Layer 104 are connected to one or more wireless communications networks, such as cellular phone networks 124 and wireless data networks 126, as well as one or more IP networks 106. Note that the cellular phone networks 124 and wireless data networks 126 may be implemented in a single network or as separate networks. The cellular phone network 124 includes one or more Short Message Service Centers (SMSCs) 128, Mobile Switching Centers (MSCs) 130, and Base Station Components (BSCs) 132, wherein the BSCs 132 include controllers and transceivers that communicate with one or more customer handsets 134 executing a POC Client 136. A handset 134 is also referred to herein as a POC mobile unit (MU), mobile station, mobile phone, cellular phone, etc. and may comprise any wireless and/or wired device. The wireless data network 126, depending on its type, e.g., GPRS or 4G/LTE, includes one or more Gateway GPRS Support Nodes (GGSNs) or Packet Gateways (PGWs) 136 and Serving GPRS Support Nodes (SGSNs) or Serving GateWays (SGWs) 138, which also communicate with POC mobile units 134 via BSCs or eNodeBs 132.

Finally, in one embodiment of the present invention, the POC System 100 is connected to one or more POC Gateway (GW) Systems 140, which are coupled to one or more Integrated Digital Enhanced Network (iDEN) Systems 142. The iDEN System 142 is a mobile telecommunications technology, developed by Motorola, which provides its users the benefits of a trunked radio and a cellular telephone, including PTT call sessions. The iDEN system 142 includes one or more interfaces 144 with the POC GW Systems 140, as well as one or more MSCs 146 controlling one or more BSCs 148 for communicating among one or more iDEN subscriber units (SUs) 150, each of which includes an iDEN Client 152. The POC GW System 140 is a network-to-network interface (NNI) gateway system that performs inter-communication or interworking between the POC System 100 and the iDEN System 142, as described in more detail below in Section 5.

### 2.1 Cellular Phone Network

The POC Service Layer 102 interacts with the SMSC 128 on the cellular phone network 124 to handle Short Message Service (SMS) operations, such as routing, forwarding and storing incoming text messages on their way to desired endpoints.

### 2.2 Wireless Data Network

The POC Service Layer 102 also interacts with the following entities on the wireless data network 126:
The GGSN/PGW 136 transfers IP packets between the POC Client 136 and the various servers:
   SIP/IP signaling messages between the POC Server 112 and POC Client 136 for control traffic exchange (i.e., control packets) for POC call sessions.
   RTP/IP, RTCP/IP and MBCP/IP packets between the Media Server 114 and POC Client 136 for bearer traffic exchange (i.e., voice packets) for POC call sessions.
   SIP/IP signaling messages between the Presence Server 110 and POC Client 136 for presence information.
   XCAP/HTTP/IP and SIP/IP signaling between the XDM Server 108 and POC Client 136 for document management.
The SMSC 128 handles authentication:
   The XDM Server 108 communicates with the SMSC 128 via SMPP/IP for receiving the authentication code required for POC Client 136 activation from the POC mobile unit 134.

### 2.3 Other IP Networks

The POC System 100 also has the capability to interact with POC mobile units 134 on other IP networks (not shown), such as the Internet, as well as private or public wireless or and/or wireline IP networks. In this regard, the POC Service Layer 102 also interacts with the following entities on other IP networks:
The IP network transfers IP packets between the POC Client 136 and the various servers:
   SIP/IP signaling messages between the POC Server 112 and POC Client 136 for control traffic exchange (i.e., control packets) for POC call sessions.
   RTP/IP, RTCP/IP and MBCP/IP packets between the Media Server 114 and POC Client 136 for bearer traffic exchange (i.e., voice packets) for POC call sessions.
   SIP/IP signaling messages between the Presence Server 110 and POC Client 136 for presence information.
   XCAP/HTTP/IP and SIP/IP signaling between the XDM Server 108 and POC Client 136 for document management.
SIP/IP signaling messages between the XDM Server 108 and POC Client 136 for receiving the authentication code required for POC Client 136 activation from the POC mobile unit 134.

### 2.4 POC Service Layer Elements

As noted above, the POC Service Layer 102 is comprised of the following elements:
POC Server 112,
Media Server 114,
Presence Server 110, and
XDM Server 108.

These elements are described in more detail below.

### 2.4.1 POC Server

The POC Server 112 handles the POC call session management and is the core for managing the POC services for the POC Clients 136 using SIP protocol. The POC Server 112 implements a Control Plane portion of Controlling and Participating POC Functions. A Controlling POC Function acts as an arbitrator for a POC Session and controls the sending of control and bearer traffic by the POC Clients 136. A Participating POC Function relays control and bearer traffic between the POC Client 136 and the POC Server 112 performing the Controlling POC Function.

### 2.4.2 Media Server

The Media Server 114 implements a User Plane portion of the Controlling and Participating POC Functions. The Media Server 114 supports the Controlling POC Function by duplicating voice packets received from an originator POC Client 136 to all recipients of the POC Session. The Media Server 114 also supports the Participating POC Function by relaying the voice packets between POC Clients 136 and the Media Server 114 supporting the Controlling POC Function. The Media Server 114 also handles packets sent to and received from the POC Clients 136 for floor control during POC call sessions.

### 2.4.3 Presence Server

The Presence Server 110 implements a presence enabler for the POC Service. The Presence Server 110 accepts, stores and distributes Presence Information for Presentities, such as POC Clients 136.

The Presence Server 110 also implements a Resource List Server (RLS), which accepts and manages subscriptions to Presence Lists. Presence Lists enable a “watcher” application to subscribe to the Presence Information of multiple Presentities using a single subscription transaction.

The Presence Server 110 uses certain XDM functions to provide these functions, which are provided by XDM Server 108.

### 2.4.4 XDM Server

The XDM Server 108 implements an XDM enabler for the POC Service. The XDM enabler defines a common mechanism that makes user-specific service-related information accessible to the functions that need them. Such information is stored in the XDM Server 108 where it can be located, accessed and manipulated (e.g., created, changed, deleted, etc.). The XDM Server 108 uses well-structured XML documents and HTTP protocol for access and manipulation of such XML documents. The XDM Server 108 also connects to the operator SMSC 128 for the purposes of POC Client 136 activation using SMS. In addition, the XDM Server 108 maintains the configuration information for all POC subscribers.

### 2.5 Management Layer Elements

As noted above, the Management Layer 104 is comprised of the following elements:
Element Management System (EMS) Server 116,
Lawful Intercept (LI) Server 118,
Web Group Provisioning (WGP) Server 122, and
Web Customer Service Representative (WCSR) Server 120.

These elements are described in more detail below.

### 2.5.1 EMS Server

The EMS Server 116 is an operations, administration, and maintenance platform for the POC System 100. The EMS Server 116 enables System Administrators to perform system-related configuration, network monitoring and network performance data collection functions. The EMS Server 116, or another dedicated server, may also provide billing functions. All functions of the EMS Server 116 are accessible through a web-based interface.

### 2.5.2 LI Server

The LI Server 118 is used for tracking services required by various Lawful Enforcement Agents (LEAs). The LI Server 118 generates and pushes an IRI (Intercept Related Information) Report for all POC Services used by a target. The target can be added or deleted in to the POC Server 112 via the LI Server 118 using a Command Line Interface (CLI).

### 2.5.3 WGP Server

The WGP Server 122 provides a web interface for Corporate Administrators to manage POC contacts and groups. The web interface includes contact and group management operations, such as create, delete and update contacts and groups.

### 2.5.4 WCSR Server

The WCSR Server 120 provides access to customer service representatives (CSRs) for managing end user provisioning and account maintenance.

Typically, it supports the following operations:
Create Subscriber account,
Update Subscriber account,
Delete Subscriber account,
Mobile number change command,
View Subscriber details (MDN, Group, Group members),
Manage Corporate Accounts,
Add CSR account,
Delete CSR account.

### 3 System Functions

The following sections describe various functions performed by each of the components of the system architecture.

### 3.1 POC Service Layer

### 3.1.1 POC Server

The POC Server 112 controls POC call sessions, including 1-1, Ad Hoc and Pre-Arranged POC call sessions. The POC Server 112 also controls Instant Personal Alerts.

The POC Server 112 expects the POC Clients 136 to setup “pre-established sessions” at the time of start up and use these sessions to make outgoing POC calls. The POC Server 112 also uses pre-established sessions to terminate incoming POC calls to the POC Clients 136. The POC Clients 136 are setup in auto-answer mode by default. The use of pre-established sessions and auto-answer mode together allow for faster call setup for POC call sessions.

The POC Server 112 allocates and manages the media ports of the Media Services 114 associated with each SIP INVITE dialog for pre-established sessions and controls the Media Servers 114 to dynamically associate these ports at run time for sending RTP packets during POC call sessions. Media ports are assigned and tracked by the POC Server 112 at the time of setting up pre-established sessions. The POC Server 112 instructs the Media Server 114 to associate the media ports of various subscribers dynamically into a session when a POC call is originated and this session is maintained for the duration of the call. The POC Server 112 also controls the floor states of the various participants in a POC call session by receiving indications from the Media Servers 114 and sending appropriate requests back to the Media Servers 114 to send MBCP messages to the participants in the POC call. The Media Server 114 uses the media ports association and current talker information to send the RTP packets from the talker's media port onto the listeners' media ports.

In addition, the POC Server 112 handles the incoming and outgoing Instant Personal Alerts (IPAs) by routing SIP MESSAGE requests to the POC Clients 136 and remote POC Servers 112 for final delivery as applicable.

The POC Server 112 uses static and dynamic data related to each subscriber to perform these functions. Static data include subscriber profile, contacts and groups. Dynamic data include the subscriber's registration state, POC settings and SIP dialog states are maintained only on the POC Server 112.

### 3.1.2 Media Server

The Media Server 114 handles the flow of data to and from the POC Clients 136 as instructed by the POC Server 112. Each Media Server 114 is controlled by a single POC Server 112, although multiple Media Servers 114 may be controlled by a POC Server 112 simultaneously.

The Media Server 114 is completely controlled by the POC Server 112. As noted above, even the media ports of the Media Server 114 are allocated by the POC Server 112 and then communicated to the Media Server 114. Likewise, floor control requests received by the Media Server 114 from POC Clients 136 are sent to the POC Server 112, and the POC Server 112 instructs the Media Server 114 appropriately. Based on these instructions, the Media Server 114 sends floor control messages to the POC Clients 136 and sends the RTP packets received from the talker to all the listeners.

### 3.1.3 Presence Server

The Presence Server 110 accepts presence information published by POC Clients 136, as well as availability information received from other entities. The Presence Server 110 keeps track of these presence states and sends notifications to various “watcher” applications whenever a presence state changes. The Presence Server 110 maintains separate subscriptions for each watcher and dynamically applies the presence authorization rules for each watcher independently.

The Presence Server 110 also accepts resource list subscriptions from the watchers, which identify one or more entities (“Presentities”) whose presence should be monitored. The Presence Server 110 then aggregates all the presence information into one or more presence notifications transmitted to each watcher. This allows watchers to subscribe to large number of Presentities without putting strain on the network as well as client and server resources.

### 3.1.4 XDM Server

The XDM Server 108 manages a database (DB) of information used by the POC System 100. Moreover, the XDM Server 108 performs client authentication and subscription functions. The XDM Server 108 also stores subscriber and group information. In addition, the XDM Server 108 interacts with the SMSC 128 to receive POC Client 136 activation commands.

All subscriber provisioning and CSR operations in the XDM Server 108 are performed through the WCSR Server 120, while corporate administrative operations, as well as contacts and group management, are handled through the WGP Server 122.

The XDM Server 108 includes a Subscriber Profile Manager module that provides subscriber management functionality, such as creation, deletion and modification of subscriber profiles. The subscriber profile includes data such as the MDN, subscriber name, subscriber type, etc. This also determines other system-wide configurations applicable for the subscriber including the maximum number of contacts and groups per subscriber and the maximum number of members per group.

The XDM Server 108 includes a Subscriber Data Manager module that manages the subscriber document operations, such as contact and group management operations, initiated by the POC Clients 136 or the WGP Server 122.

### 3.2 Management Layer

### 3.2.1 EMS Server

The EMS Server 116 is the central management entity in the system and includes the following modules:
A central application where all management business logic resides.
A web server for serving the network operator's internal users. A corresponding client provides a user interface for viewing fault, configuration, performance and security information.
A subsystem is provided for health monitoring of network elements deployed in the system and also to issue any maintenance commands as applicable.

### 3.2.2 WCSR Server

The WCSR Server 120 provides a web user interface for customer service representatives (CSRs) to carry out various operations. The web user interface provides access to CSRs for managing subscriber provisioning and account maintenance. Typically, it supports the following operations.
Create Subscriber account,
Update Subscriber account,
Delete Subscriber account,
Mobile number change command,
Forced synchronization of a Subscriber,
Deactivate a Subscriber account,
Reactivate a Subscriber account,
View Subscriber details, such as MDN, Group, Group members.

### 3.2.3 WGP Server

The WGP Server 122 allows provides for central management of all corporate subscribers and associated contacts and groups within a corporation. The WGP Server 122 allows Corporate Administrators to manage contacts and groups for corporate subscribers.

The WGP Server 122 includes a Corporate Administration Tool (CAT) that is used by Corporate Administrators to manage contacts and groups of corporate subscribers. The CAT has a Web User Interface for Corporate Administrators that supports the following operations:
Group management,
Contact management, and
Associations between corporations.

With regard to group management, the CAT of the WGP Server 122 includes the following operations:
Create, Update, Delete and View Corporate Groups,
Add, Update, Delete and View Members of a Corporate Group,
Manage Subscribers,
Activate and Deactivate a Corporate Subscriber,
Change a Subscriber type from “Corporate” to “Corporate And Public”, and vice versa,
Restrict Availability, i.e., do not allow subscriber to change their presence status, and
Manage number porting or name change via phone assignment.

With regard to contact management, the CAT of the WGP Server 122 includes the following operations:
Phone list management,
N×N Contact Add (e.g., N contacts may be members of N groups),
Add, Update, Delete and View Contacts for a specific subscriber, and
Export and Import contacts at both the subscriber and corporate level.

With regard to associations between corporations, the CAT of the WGP Server 122 includes the following operations:
Corporate Associations Attributes,
Association Name,
Association ID,
Association Mode (e.g., One-way, Two-way), and
Restricted List.

Once the association is created and accepted, Corporate Administrators can create contacts and groups using the association policies. Administrators from other corporations can view the contacts, and may or may not have the capability to add, update or delete the contacts.
Corporate ID associated per corporate subscriber,
Central management of corporate subscribers, groups, and contacts,
Intercorporate associations, including contacts and white-lists,
Phone list management (e.g., N×N contact add),
Restrict Availability, and
Import and Export contacts at both the subscriber and corporate level.

Note that, if the association is deleted, then usually all intercorporate contacts and group members will be deleted.

### 3.3 POC Client

The POC Client 136 is an OMA-compatible client application executed on a POC mobile unit 134. The following features are supported by the POC Client 136:
POC Calls and Instant Personal Alert,
Presence, and
Contact and Group Management.

The POC Client 136 includes a database module, a presence module, an XDM module and a client module.

The database module stores configuration information, presence information, contact and group information, user settings, and other information in an optimized and persistent way. Information is preserved when the user unregisters with the POC Server 112 or power cycles the device. The database module also has a mechanism to reset the data and synchronize from the XDM Server 108 when the data in the database module is corrupt or unreadable.

The presence module creates and maintains the presence information for the subscriber. Typically, the presence information supports Available, Unavailable and Do-not-Disturb (DnD) states. The presence module also subscribes to the Presence Server 110 as a “watcher” of all contacts in the POC mobile unit 134 and updates the user interface of the POC mobile unit 134 whenever it receives a notification with such presence information.

The XDM module communicates with the XDM Server 108 for management of contacts and groups. The XDM module may subscribe with the XDM Server 108 to send and receive any changes to the contacts or group list, and updates the user interface of the POC mobile unit 134 based on the notifications it receives from the XDM Server 108.

The client module provides the most important function of making and receiving POC calls. To support POC calls, the client module creates and maintains pre-established sessions with the POC Server 112. The client module supports 1-1, Ad Hoc and Pre-Arranged POC calls. The client module also supports sending and receiving Instant Personal Alerts (IPA).

### 4 State Diagram for a POC Call Session

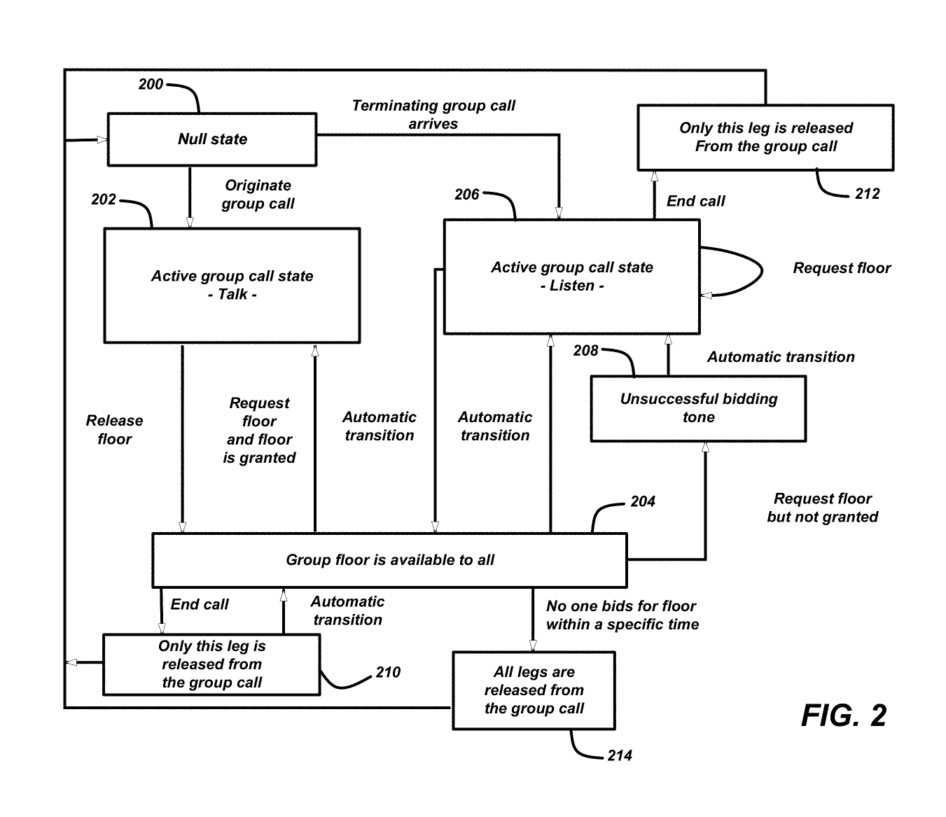

FIG. 2 is a state diagram that illustrates the operation of a POC call session in the POC System 100 according to an embodiment.

State 200 represents a POC Client 136 in a NULL state, i.e., the start of the logic. A transition out of this state is triggered by a user making a request to originate a POC call, or by a request being made to terminate a POC call at the POC mobile unit 134. A request to originate a POC call is normally made by pressing a POC button, but may be initiated in this embodiment by dialing some sequence of one or more numbers on the POC mobile unit 134 that are interpreted by the POC Server 112, by pressing one or more other keys on the POC mobile unit 134 that are interpreted by the POC Server 112, by speaking one or more commands that are interpreted by the POC Server 112, or by some other means.

State 202 represents the POC Client 136 in an active group call state, having received a “floor grant” (permit to speak). In this state, the user receives a chirp tone that indicates that the user may start talking. The user responds by talking on the POC mobile unit 134. The POC mobile unit 134 uses the reverse traffic channel to send voice frames to the Media Server 114, and the Media Server 114 switches voice frames only in one direction, i.e., from talker to one or more listeners, which ensures the half-duplex operation required for a POC call.

State 204 represents the group “floor” being available to all members of the group. When the talking user signals that the floor is released, the floor is available to all group members. The signal to release the floor is normally made by releasing the POC button, but may be performed in this embodiment by voice activity detection, e.g., by not speaking for some time period (which is interpreted by the POC Server 112 as a release command). All members of the group receive a “free floor” tone on their POC mobile unit 134. A user who requests the floor first (in the “free-floor” state), for example, is granted the floor, wherein the POC System 100 sends a chirp tone to the successful user. The signal to request the floor is normally made by pressing the POC button, but may be performed in this embodiment by voice activity detection, e.g., by speaking for some time period (which is interpreted by the POC Server 112 as a request command).

State 206 represents the POC Client 136 being in an active group call state. In this state, the user is listening to the group call. If a non-talking user requests the floor in the active group call state, the user does not receive any response from the POC System 100 and remains in the same functional state. As noted above, the signal to request the floor is normally made by pressing the POC button, but may be performed in this embodiment by voice activity detection, e.g., by speaking for some time period (which is interpreted by the POC Server 112 as a request command).

State 208 represents a user receiving an “unsuccessful bidding” tone on his POC mobile unit 134, after the user has requested the floor, but was not granted the floor, of the group call. The user subsequently listens to the voice message of the talking user.

Non-talking users (including the talking user who must release the floor to make it available for others) can request the POC System 100 to end their respective call legs explicitly.

State 210 represents a terminating leg being released from the call after the user ends the call.

State 212 also represents a terminating leg being released from the call after the user ends the call.

State 214 represents all terminating legs being released from the call when no user makes a request for the within a specified time period, or after all users have ended their respective call legs.

A similar state diagram would illustrate the operation of a PTT call session in the iDEN system 142 according to an embodiment.

5.0 Inter-Communication between iDEN and POC Systems

Among the prevalent Push-to-Talk (PTT) technologies, iDEN systems serve a large segment of users and have been deployed at many sites across the world. However, several of the iDEN systems have been shut down or are in the process of being shut down, and the iDEN subscribers are migrating to alternate PTT systems with the POC System 100 being one such system. Therefore, there is a need to interwork between the POC System 100 and iDEN System 142 in order to facilitate seamless migration of the iDEN subscribers without disrupting the communication between the POC user community and the iDEN user community during the migration.

Embodiments describe several methods to enable a standards-based POC System 100 to connect with an iDEN System 142. Interworking between the POC System 100 and iDEN System 142 is accomplished by means of the POC Gateway (GW) System 140, which bridges the iDEN and POC network-to-network interface (NNI) protocols, and causes the POC Systems 100 to be exposed to the iDEN System 142 as an emulated iDEN System, and causes the iDEN Systems 142 to be exposed to the POC System 100 as an emulated POC System. The interworking POC GW System 140 supports private calls, group calls and call alerts across the systems.

Further, over the years, the iDEN user community has become accustomed to certain behavior patterns and it is necessary to retain the same user experience for the iDEN users even after they migrate to the POC System 100. More specifically, iDEN users are addressed using a hierarchical addressing format known, as a Universal Fleet Member Identifier (UFMI), that facilitates users to reach out to other community members using an abbreviated dialing format, such as “*121” for calling a contact and “#55” for calling a group. All methods for POC-iDEN interworking described herein allow the iDEN subscribers who have migrated to the POC System 100 to retain their UFMI and to continue to use abbreviated dialing in the manner of iDEN service usage norms.

POC System 100 subscribers are identified by MDNs and addressed by TEL or SIP URIs, whereas iDEN Systems 142 use UFMIs as subscriber identities. The POC GW System 140 creates and manages ID mappings in order to make POC subscribers and groups addressable by peer iDEN Systems 142. Similarly, the POC GW System 140 also creates ID mappings to present external subscriber and group IDs to the POC System 100 subscribers. The POC GW System 140 exposes POC Clients 136 and groups to the iDEN System 142 using iDEN UFMIs and iDEN Group IDs. Similarly, iDEN UFMIs and iDEN Group IDs are exposed to the POC System 100 using dummy or PseudoMDNs and POC Group IDs, and are addressable using TEL or SIP URIs from the POC System 100. Additionally, the POC System 100 is also enhanced to allow the POC System 100 subscribers to address the iDEN System 142 contacts and groups directly using their UFMIs and iDEN group IDs, and to perform abbreviated dialing to reach out to iDEN System 142 contacts and groups.

The POC GW System 140 is an independently managed system, and it is deployed separately from the POC System 100. The POC GW System 140 is comprised of at least the following components:

1. One or more POC GW Server instances, which are based on the POC Server 112, along with its associated Media Server instances, which are based on the Media Server 114.

2. One or more POC GW Data Management (Mgmt) Server instances, which are based on the XDM Server 108, along with its Interface Server instances, which are based on the WCSR Server 120 and WGP Server 122, and which expose the data management services through a web service interface and other types of interfaces.

3. A Database (DB) maintained by the POC GW Data Management Server for persisting iDEN UFMI-POC MDN user and group identity mappings.

4. A network-to-network interface (NNI) for connecting to the POC System 100, which allows the POC System 100 to be insulated from the different variants of the iDEN Systems' 142 interfaces.

The interworking of the POC GW System 140 is realized using three different methods, where the applicability of each of these methods depends on the type of interface 144 to the iDEN System 142. Specifically, embodiments provide the following three methods of connecting the POC System 100 to the iDEN System 142:

1. Using an iDEN Gateway (iGW) as the interface 144. This method is applicable when the iDEN System 142 exposes the iGW 144 to allow a peer iDEN System to communicate with it.

2. Using a POC-iDEN Soft Bridge as the interface 144, wherein the POC-iDEN Soft Bridge is based on a Windows desktop iDEN client. This method is applicable when the iDEN System 142 supports a PC-based client that allows the user to access the iDEN System's 142 services over an IP interface.

3. Using a programmatically-controllable Smart Donor Radio System as the interface 144. This method is applicable when neither of methods 1 or 2 above are available for interfacing with the iDEN System 142. In this case, the programmatically-controllable Smart Donor Radio System 144 is used to connect to the iDEN System 142 over an air interface on one side and is used to connect to the POC System 100 over an IP interface on the other side.

Enabling POC-iDEN interworking in this manner will increase the interface 144 options to the POC System 100, will increase user adoption and will reduce user churn, thereby making the POC System 100 more valuable to service providers.

5.1 Method 1: Using an iDEN Gateway (iGW) as the Interface

### 5.1.1 Architecture

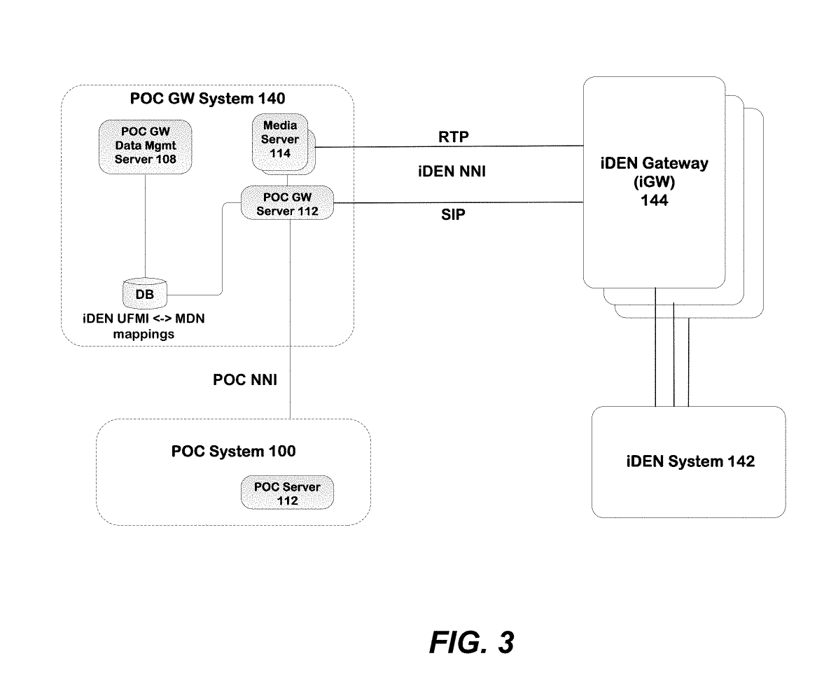

FIG. 3 illustrates a POC-iDEN interworking architecture using an iDEN Gateway (iGW) as the interface 144. Specifically, the POC Gateway System 140 interfaces with an iDEN System 142 through the iGW 144 using the SIP protocol:
Private and Group Calls: Standard SIP signaling using INVITE, UPDATE and BYE methods.
Floor Control: SIP INFO method is used for exchanging floor arbitration messages.
Call Alerts: SIP INVITE method with proprietary message body is used for call alerts.
Media: Media is delivered over an RTP stream, which is setup using standard SDP negotiation. Several codecs, including G.711, EVRC, and AMBE++, are supported by the iGW 144.

### 5.1.2 User Addressing

When iDEN interoperability is enabled for a corporate account in the POC System 100, all subscribers in that account are assigned an iDEN UFMI. When migrating from an iDEN System 142 to a POC System 100, the user can retain his current iDEN UFMI. POC System 100 subscribers can also be addressed using their MDN. The POC System 100 subscriber can directly dial out to iDEN UFMIs and groups, and can also include iDEN UFMIs in their contact lists and groups. Further, each group in an iDEN interoperability-enabled account is associated with an iDEN group ID and such groups are allowed to include iDEN UFMIs as group members.

Further, there exist POC Clients 136 which are not capable of dialing out to iDEN contacts and groups using the iDEN addressing format. The POC System 100 provides an interface 122 for the corporate administrator to set up PseudoMDN mappings to enable these POC System 100 subscribers to reach out to their iDEN contacts. Through this interface 122, each iDEN System 142 user who needs to be contacted from the POC System 100 is associated with a unique MDN, thereby making that iDEN System 142 user addressable from the POC System 100.

### 5.1.3 Call Flows

### 5.1.3.1 Overview

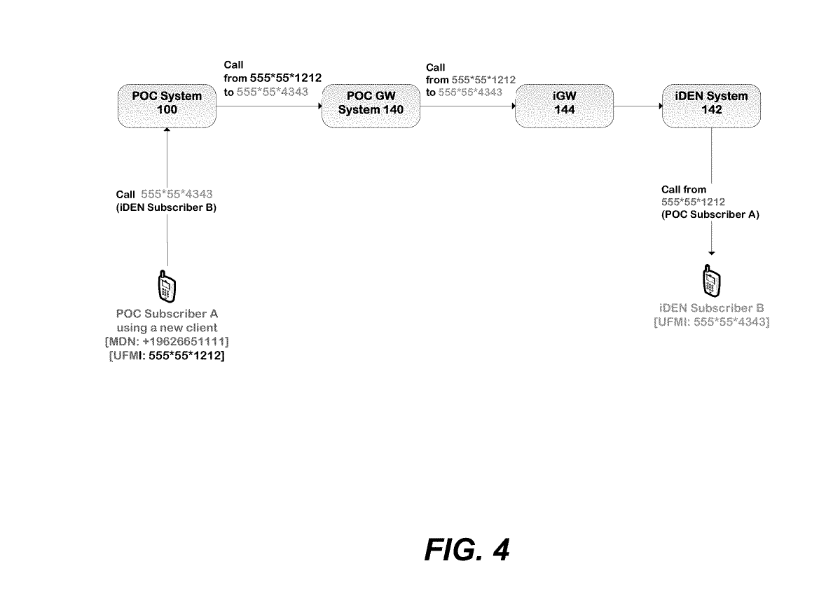

FIG. 4 illustrates a POC-iDEN private call through the iGW 144. This figure explains the user experience during a private call between a POC System 100 subscriber and an iDEN System 142 subscriber.

Each POC System 100 subscriber is assigned an UFMI, which could be automatically generated by the system or configured through the corporate administrator tool (CAT) interface of the WGP Server 122. The POC System 100 subscriber calls an iDEN System 142 contact using the iDEN UFMI of that contact. This call is conveyed to the iDEN System 142 via the POC GW System 140 and the iGW 144. When this iDEN System 142 contact receives the call, the subscriber sees the UFMI assigned to the POC System 100 subscriber as the caller ID. When PseudoMDNs are used to address iDEN System 142 contacts, the POC GW System 140 maps the PseudoMDNs in the paging list to the corresponding actual iDEN UFMIs when forwarding the call to the iGW 144.

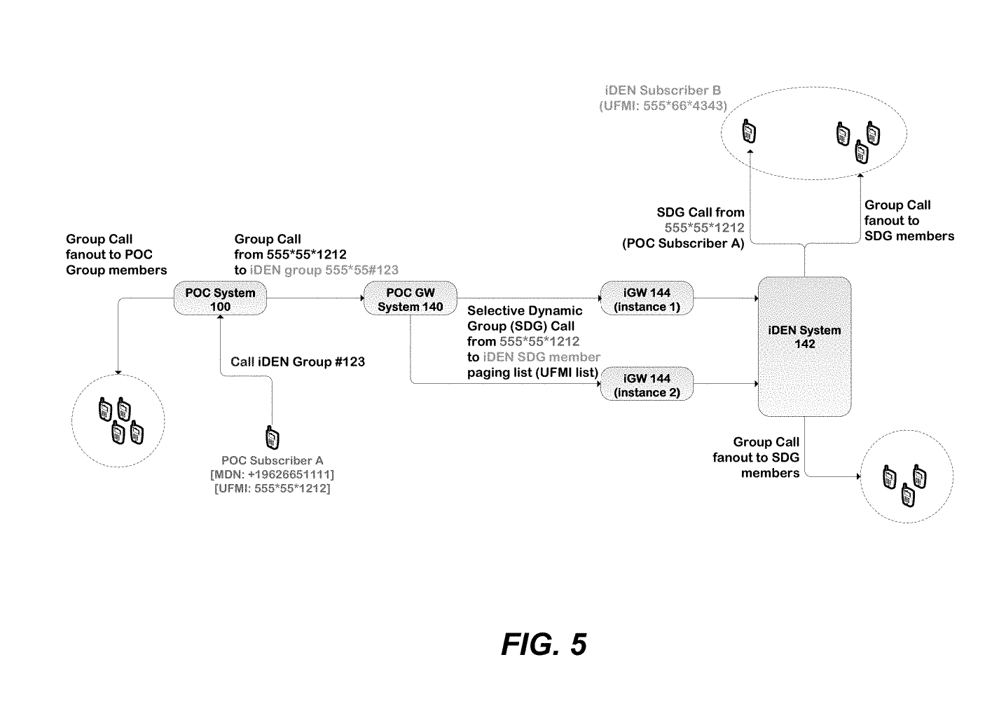

FIG. 5 illustrates a POC-iDEN group call through the iGW 144. This figure explains the group call scenario where the group includes participants spread across the POC Systems 100 and iDEN Systems 142.

The POC System 100 groups in an iDEN interoperability-enabled corporate accounts are associated with an iDEN group ID (e.g. ‘#123’). The group can include members from the POC System 100 as well as the iDEN System 142. The POC System 100 subscriber can make a call to this group by dialing the iDEN group id associated with that group.

The POC GW System 140 bridges the iDEN System 142 subscribers into this group call. The POC GW System 140 connects with one or more iGW 144 instances and follows the procedure defined for placing Selective Dynamic Group (SDG) calls as per the iGW 144 interface protocol.

The POC GW System 140 agglomerates the target UFMIs to separate UFMI paging lists, where one paging list corresponds to each iGW 144 instance that is involved in the call. As part of the agglomeration procedure, the POG GW System identifies the iGW 144 instance that is currently serving each of the iDEN System 142 subscribers that need to be connected to the group call and places the UFMI into the corresponding paging list. The POC GW System 140 then places a single call leg to each iGW 144 and provides the paging list corresponding to that iGW 144 instance. On receiving this group call, the iGW 144 performs a group call fan out to connect all the UFMIs provided in the paging list.

When PseudoMDNs are used to address iDEN System 142 contacts, the POC GW System 140 maps the PseudoMDNs in the paging list to the corresponding actual iDEN UFMIs.

### 5.1.3.2 Private Call

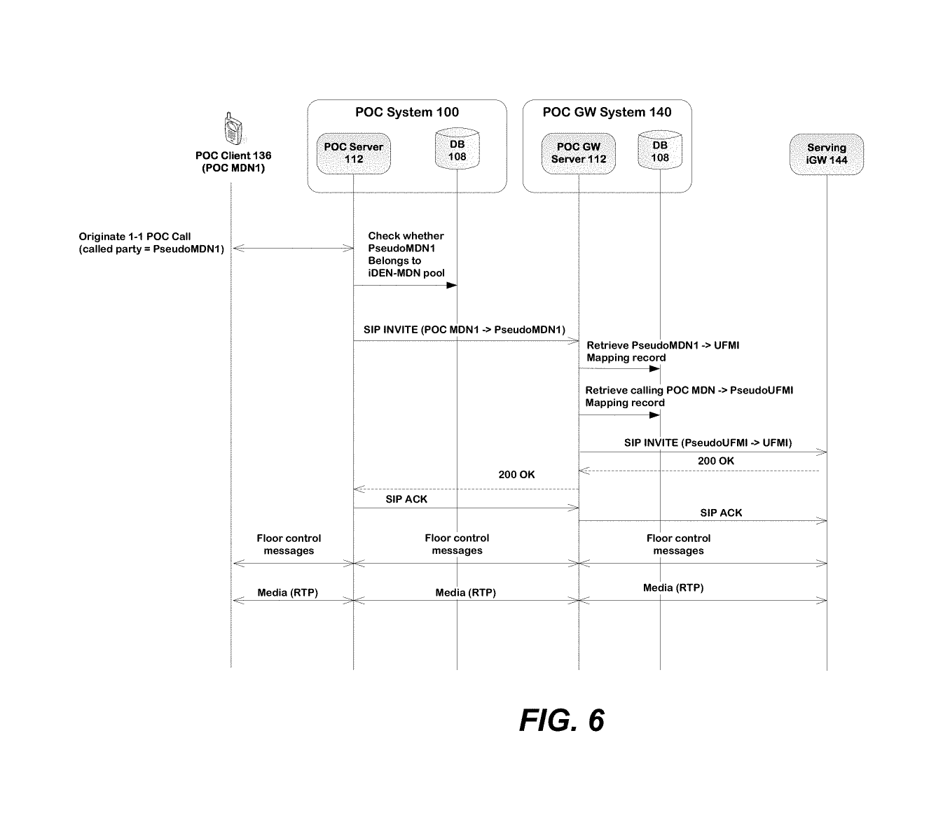

FIG. 6 illustrates a private call through the iGW 144 initiated by a POC Client 136. Specifically, this call flow shows a private call from a POC Client 136 to an iDEN Client 152.

It involves the following steps:

1. The POC Client 136 originates a private 1-1 call to an iDEN System 142 contact by dialing out the PseudoMDN associated with the iDEN System 142 contact. Alternately, the POC Client 136 may directly dial out to the iDEN System 142 contact's UFMI.

2. The POC Server 112 receives the call setup request from the POC Client 136 and forwards it the POC GW System 140.

3. The POC GW System 140 maps the called party PseudoMDN to the actual called party iDEN UFMI and it also maps the calling party MDN to the UFMI assigned to that POC System 100 user.

4. The POC GW System 140 then forwards the call to the iGW 144 and completes the call setup as required by the iGW 144 interface.

5. Floor control messages and media (RTP) are transmitted in both directions in the context of this private call dialog.

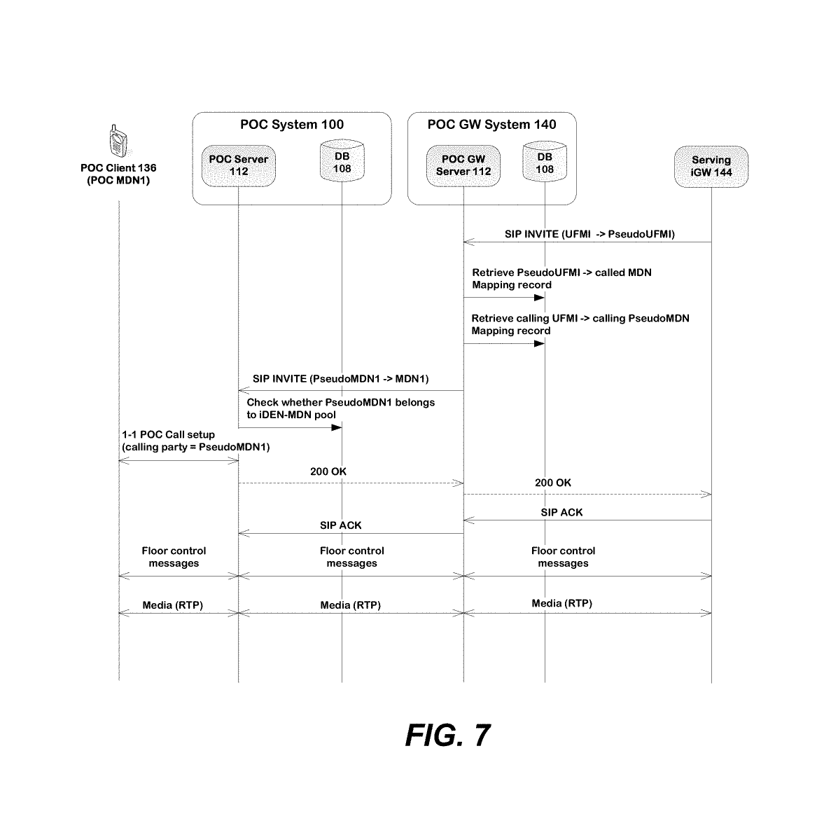

FIG. 7 illustrates a private call through the iGW 144 initiated by an iDEN Client 152. Specifically, this call flow shows a private call from an iDEN Client 152 to a POC Client 136.

It involves the following steps:

1. When an iDEN Client 152 calls a POC System 100 contact, the iGW 144 currently handling that iDEN Client 152 places a call to the POC GW System 140 with the called party as the UFMI associated with the POC System 100 user.

2. The POC GW System 140 maps the called party UFMI to the actual MDN of the POC System 100 user and completes the call setup towards the POC System 100. Further, the POC GW System 140 may also map the calling party UFMI to the PseudoMDN associated with that iDEN System 142 user when forwarding the call to the POC System 100.

3. The POC System 100 connects the POC Client 136 on receiving the call setup request from the POC GW System 140.

4. Floor control messages and media (RTP) are transmitted in both directions in the context of this private call dialog

### 5.1.1.3 Floor Control

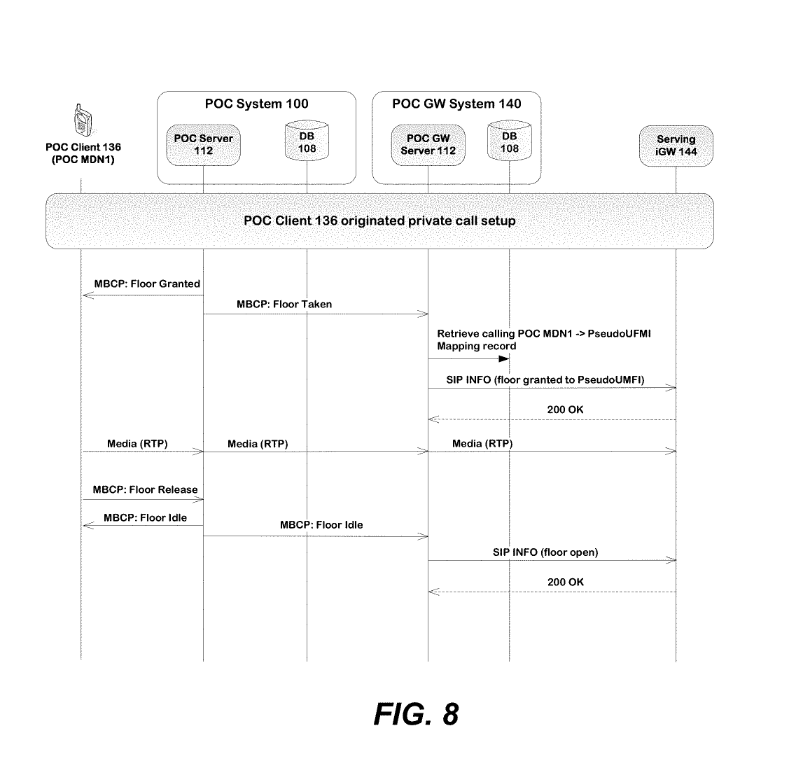

FIG. 8 illustrates POC/PTT floor control through the iGW 144. This call flow shows a typical floor exchange sequence during a private call between a POC Client 136 and an iDEN Client 152 (not shown). The POC Client 136 uses the MCBP protocol for floor control and the iGW 144 uses the SIP INFO method for conveying floor control information. The POC GW System 140 performs the required protocol mapping.

The following steps are involved in the above example flow where a POC Client 136 takes the floor and then releases the floor after transmitting a media burst:

1. When the POC Client 136 initiates a private call towards the iGW 144, and thereafter the iDEN Client 152, the POC Server 112 grants the floor initially to the POC Client 136 as it is the call originator and indicates that the floor taken event is sent to the iDEN Client 152.

2. The POC GW System 140 receives the floor taken event from the POC Server 112 and relays it to the iGW 144 using the SIP INFO method after mapping the caller and called MDNs to the corresponding UFMIs.

3. The media burst is transmitted by the POC Client 136 to the iGW 144, and thereafter the iDEN Client 152.

4. After the media burst transmission is completed, the POC Client 136 releases the floor by sending a MBCP release message.

5. The POC Server 112 changes the floor state to ‘idle’ and transmits the floor idle event to both parties in the call.

6. The POC GW System 140 receives this floor idle event from the POC Server 112 and relays it to the iGW 144 using the SIP INFO method after mapping the caller and called MDNs to the corresponding UFMIs.

### 5.1.3.4 Group Call

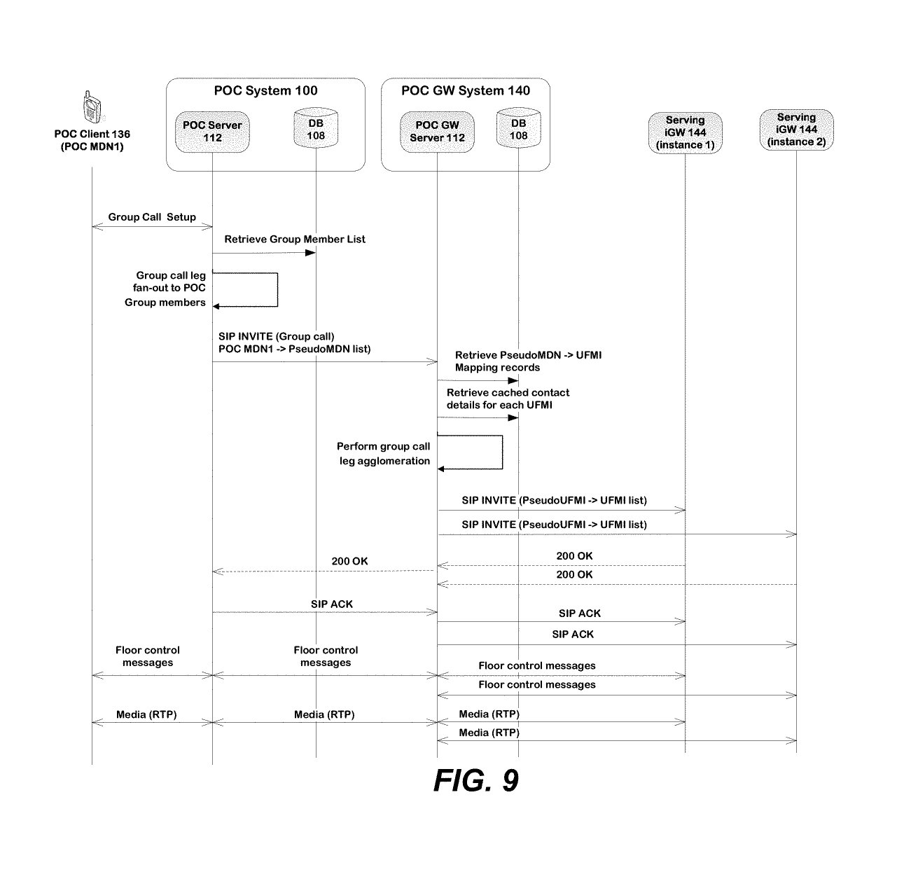

FIG. 9 illustrates a POC group call through the iGW 144. Specifically, this call flow shows a group call from a POC Client 136 to an iDEN group. In this example, the POC Client 136 originates a group call to an iDEN group by dialing out the POC group which is associated with an iDEN group. The group includes one or more members from the POC System 100 and one or more members from the iDEN System 142.

It involves the following steps:

1. When the POC Client 136 originates a group call to an iDEN group, the POC Server 112 performs a local fan-out to connect the other POC Clients 136 to the group call and forwards a call leg towards the POC GW System 140 in order to bridge the iDEN Clients 152 into the group call.

2. The POC GW System 140 maps the MDNs of the caller and the iDEN group members to the corresponding group members.

3. The POC GW System 140 performs a group agglomeration procedure to identify the iGW 144 instances that it is needs to connect to in order to bridge all the iDEN participants into the call.

4. The POC GW System 140 then sets up a SIP INVITE dialog with each of the iGW 144 instances identified by the group agglomeration procedure and completes the call setup as required by the iGW 144 interface.

5. Floor control messages and media (RTP) are transmitted in both directions in the context of this group call dialog. When forwarding the floor control events and media bursts from the POC System 100 to the iDEN System 142, the POC GW System 140 creates replicas of this information and forwards it to each of the iGW 144 instances involved in the call.

### 5.2 Method 2: Using a POC-iDEN Soft Bridge as the Interface

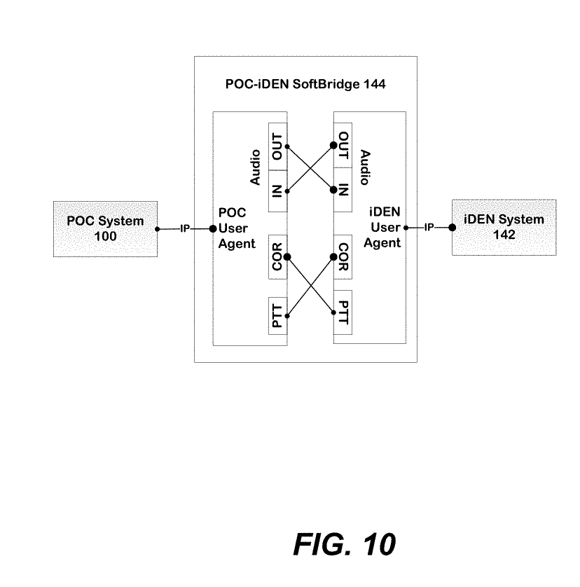

In the case of iDEN Systems 142 where the iGW 144 interface is not available to connect to a peer iDEN System 142, it is possible to interwork with the iDEN System 142 in a cost effective manner by using a POC-iDEN Soft Bridge as the interface 144. A POC-iDEN Soft Bridge 144 is a software-based virtual appliance that uses a POC User Agent to connect to the POC System 100 over an IP interface on one side, and that uses an iDEN User Agent to connect to the iDEN System 142 on the other side. The POC-iDEN Soft Bridge 144 acts as a back-to-back user agent to bridge the POC System 100 and the iDEN System 142. It intercepts PTT audio transmissions (OUT, IN) and PTT control signals (PTT, COR) from one system, and relays them to the other system, as shown in FIG. 10.

Specifically, the POC-iDEN Soft Bridge 144 intercepts output signals from the iDEN User Agent part and interprets this information to determine the signaling information pertaining to call setup and floor control (PTT) from the iDEN System 142 via the iDEN User Agent part, and relays this signaling information to the POC System 100 via the POC User Agent part, by triggering corresponding (COR) keystroke input sequences to the keypad interface of the iDEN User Agent part. Similarly, it receives the signaling information pertaining to call setup and floor control (PTT) from the POC System 100 via the POC User Agent part, and relays this information to the iDEN System 142 via the iDEN User Agent part by triggering corresponding (COR) keystroke input sequences to the keypad interface of the iDEN User Agent part.

### 5.2.1 Architecture

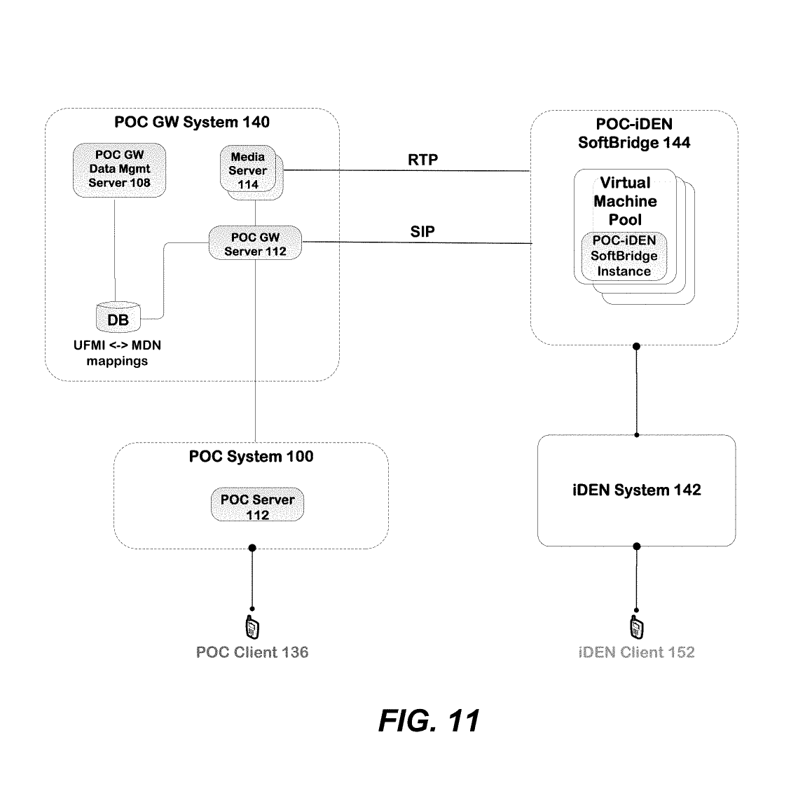

FIG. 11 illustrates a POC-iDEN interworking architecture using the POC-iDEN Soft Bridge 144.

In one of the embodiments of this system, the POC-iDEN Soft Bridge 144 runs on a computer in a Windows™ operating system environment. The POC-iDEN Soft Bridge 144 instance may be virtualized, wherein the computer hosts a virtual machine pool of POC-iDEN Soft Bridge 144 instances. Moreover, these POC-iDEN Soft Bridge 144 instances may be implemented on the same computers as the POC GW System 140, although they may be implemented on different computers as well.

### 5.2.2 User Addressing

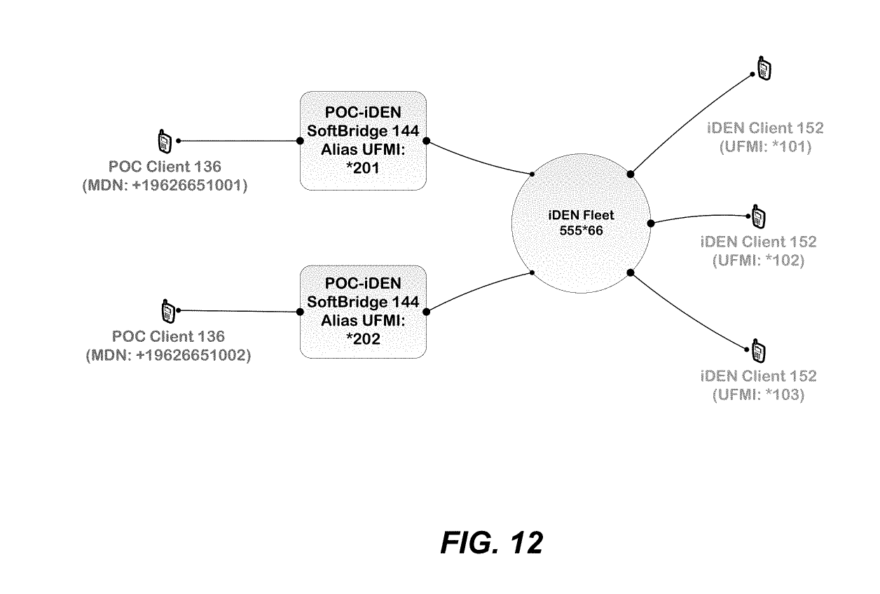

The POC-iDEN Soft Bridge 144 assigns an alias UFMI to the POC user, and allows the POC user to become a member of an iDEN fleet, as shown in FIG. 12. Moreover, it enables seamless migration of subscribers from an iDEN System 142 to a POC System 100 by allowing iDEN System 142 subscribers to retain their current UFMI when migrating to the POC System 100.

When iDEN interoperability is enabled for a corporate account in the POC System 100, each of the subscribers in that account may be associated with a POC-iDEN Soft Bridge 144 and assigned an iDEN UFMI. The UFMI may be automatically generated or be manually assigned through the CAT interface of the WGP Server 122. When migrating from an iDEN System 142 to a POC System 100, the UFMI currently being used to identify the user is assigned to the POC-iDEN Soft Bridge 144 instance associated with that user. This allows the user to retain his current iDEN UFMI.

POC System 100 subscribers can also be addressed using their MDN. A POC System 100 subscriber can directly dial out to iDEN UFMIs and groups, and can include iDEN UFMIs in their contact lists and groups. Further, each group in an iDEN interoperability-enabled account may be associated with an iDEN group ID, and such groups are allowed to include iDEN UFMIs as group members.

### 5.2.3 Call Flows

### 5.2.3.1 Private Call

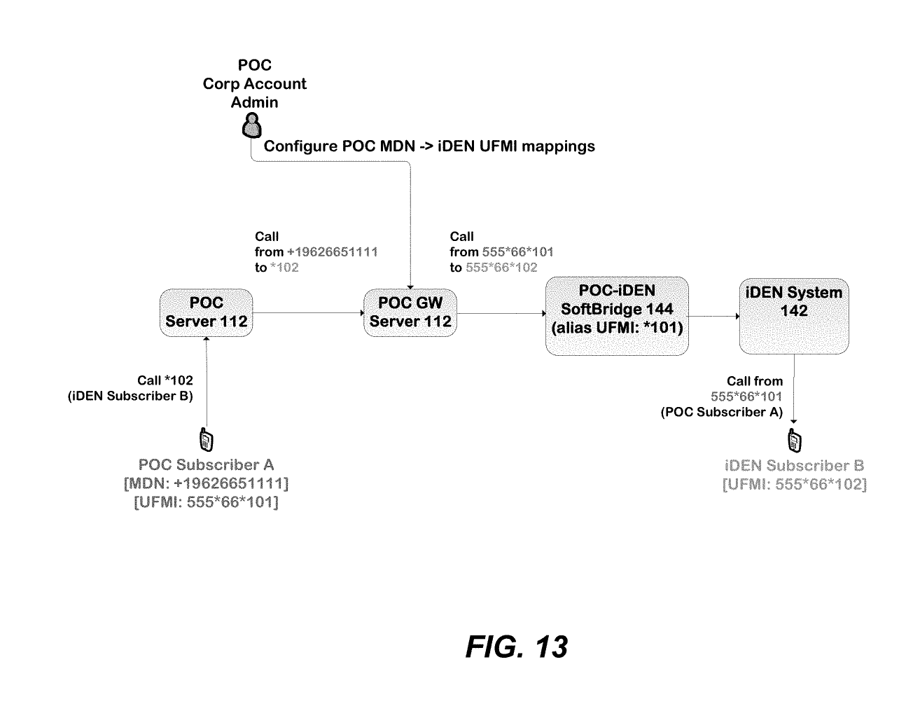

FIG. 13 illustrates a private call through the POC-iDEN Soft Bridge 144 initiated by a POC Client 136.

The POC System 100 subscriber calls an iDEN contact using the iDEN UFMI of that contact. This call is conveyed to the iDEN System 142 via the POC GW System 140 and the corresponding POC-iDEN Soft Bridge 144 instance associated with the caller. When this iDEN contact receives the call, the subscriber sees the UFMI assigned to the POC System 100 subscriber as the caller ID.

### 5.2.3.2 Group Call

To setup a group call across the POC System 100 and the iDEN System 142, a MDN is assigned to a POC-iDEN Soft Bridge 144 instance, wherein the MDN is included in a POC group and this POC group is associated with a iDEN group by including the UFMI of the POC-iDEN Soft Bridge 144 instance in that iDEN group. When the POC-iDEN Soft Bridge 144 receives a group call leg from a POC System 100 corresponding to the associated MDN, it initiates a group call to the corresponding group on the iDEN System 142. Similarly, when the POC-iDEN Soft Bridge 144 receives a group call leg from the iDEN System 142 corresponding to the associated UFMI, it triggers a group call to the corresponding group on the POC System 100.

### 5.3 Method 3: Using a Smart Donor Radio as the Interface

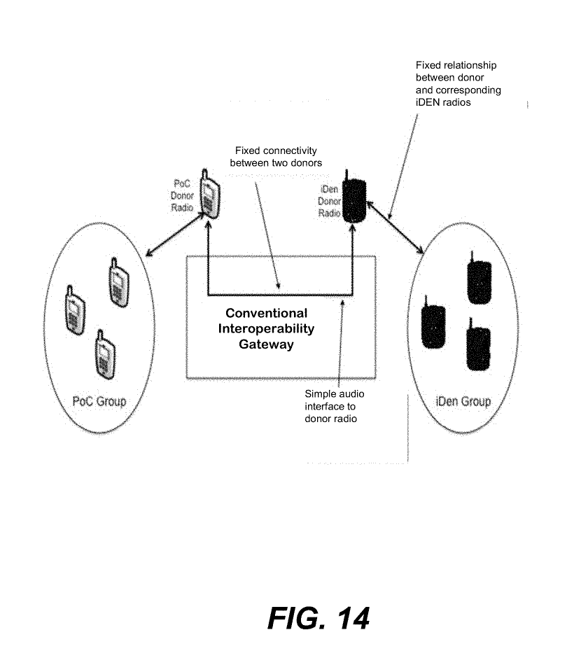

When an iDEN System 142 does not have the iGW 144 capability enabled to communicate with a peer iDEN System using network level interfaces, it is virtually a closed PTT system. Conventionally, a simple donor radio solution, such as the one depicted in FIG. 14, is used for interworking with closed PTT systems.

The simple donor radio solution provides only a conventional interoperability gateway with fixed mappings and it requires dedicated allocation of donor radios. In most cases, it is economically feasible only for interworking PTT talk groups.

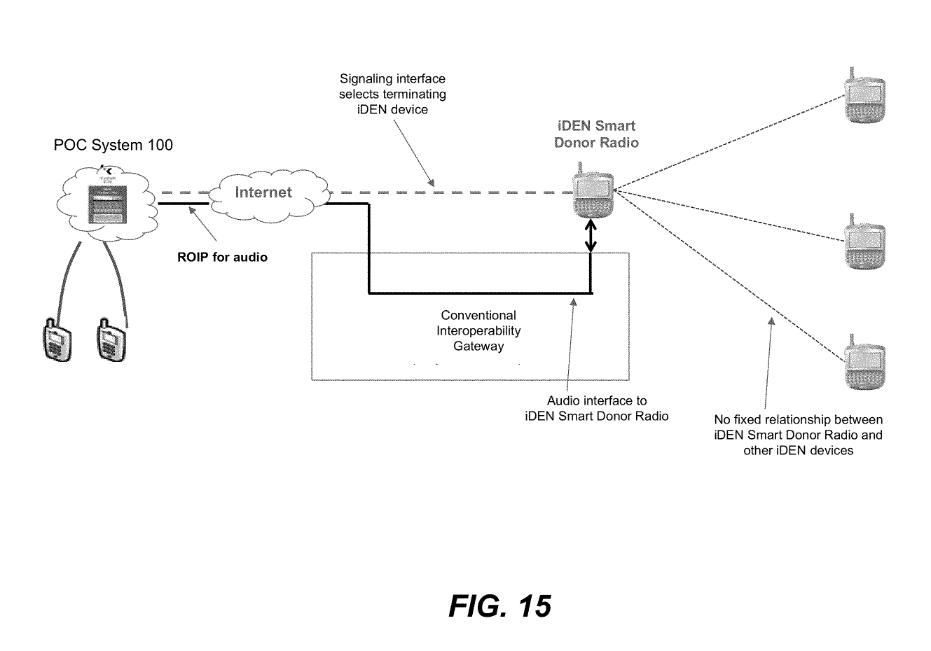

Embodiments propose a more cost effective solution using a Smart Donor Radio System as the interface 144, which allows the relationship between the donor device and the actual iDEN subscriber end point to be configured dynamically through a programmatic interface as shown in FIG. 15.

A smart donor radio shown in FIG. 15 is similar to the simple donor radio solution shown in FIG. 14. However, unlike the simple donor radio, the smart donor radio can be programmed dynamically using the AT command interface to originate calls to different iDEN System 142 peers. The smart donor radio provides a command interface that is used for setting the called party number, PTT floor control, receiving caller/talker identification for incoming calls, call state updates, and so on.

### 5.3.1 Architecture

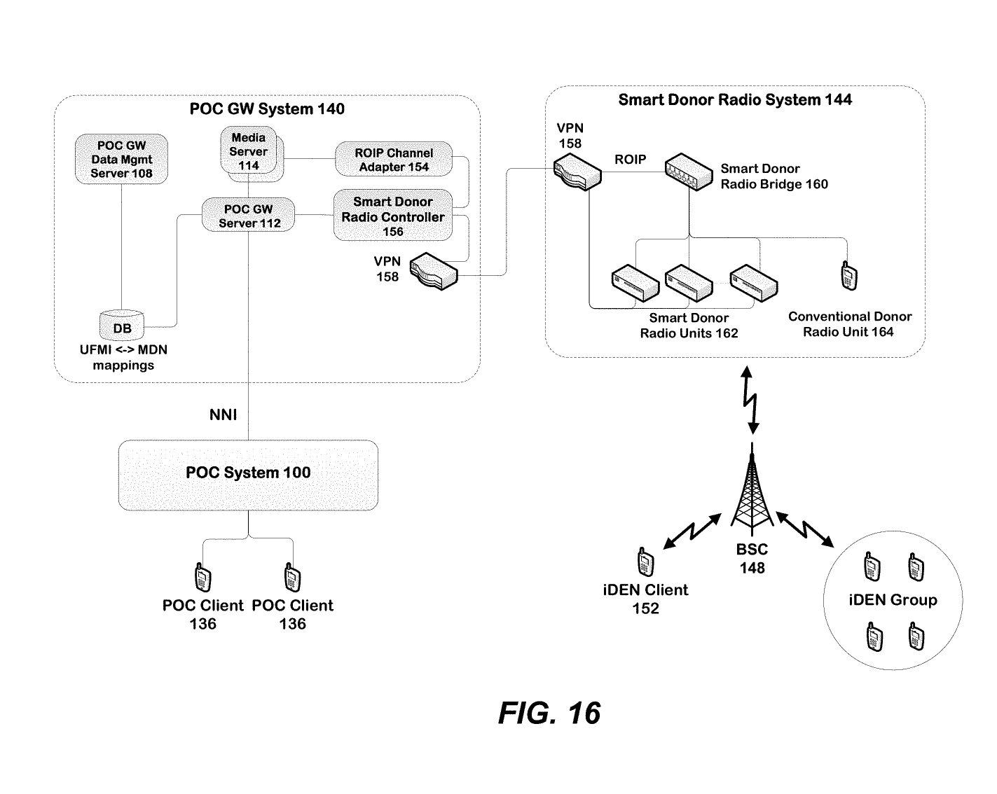

FIG. 16 illustrates a POC-iDEN interworking architecture using a Smart Donor Radio System as the interface 144.

In this embodiment, the POC GW System 140 also includes the following components:

1. A Radio Over IP (ROIP) Channel Adapter 154, which connects the POC GW Media Server 114 to the Smart Donor Radio System 144, and performs protocol conversion between RTP and ROIP.

2. A Smart Donor Radio Controller 156, which enables the POC GW Server 112 to control the Smart Donor Radio System 144 by converting the signaling events into a command interface protocol.

3. One or more VPN interfaces 158 to connect to the Smart Donor Radio System 144, which typically comprises customer premises equipment.

The Smart Donor Radio System 144 comprises the following components:

1. One or more VPN interfaces 158 to connect to the POC GW System 140.

2. Customer premises equipment that includes the following components:
a. One or more Smart Donor Radio Bridges 160.
b. One or more Smart Donor Radio Units 162.
c. One or more Conventional Donor Radio Units 164.

The POC GW System 140 connects to one or more Smart Donor Radio Bridges 160 using the ROIP protocol for handling media transmissions, and it also connects with one or more Smart Donor Radio Units 162 and one or more Conventional Donor Radio Units 164 over a control interface, which is realized using an AT command interface transmitted on UDP over IP in one of the implementations. Generally, the Smart Donor Radio System 144 requires a lesser amount of customer premises equipment when compared to a simple donor radio solution and it is therefore more cost effective.

### 5.3.2 User Addressing

When there is no network level interface available for the iDEN System 142, the only way to provide an iDEN UFMI to a POC System 100 subscriber is by associating that subscriber with an iDEN donor radio. Despite the fact that the Smart Donor Radio System 144 requires a far lesser amount of customer premises equipment than the simple donor radio solution, even this reduced quantity of equipment could be fairly expensive, if each POC Client 136 is associated with a dedicated Smart Donor Radio Unit 162. Further, such dedicated assignments would cause the Smart Donor Radio Units 162 to be idle for a significant portion of time. Therefore, there is scope to optimize the utilization of this equipment by applying methods that minimize the idle time on the Smart Donor Radio Units 162.

One such method for optimization is by treating the Smart Donor Radio Units 162 as a shared resource pool, in which each Smart Donor Radio Unit 162 is associated with multiple contact mappings, instead of being associated with a specific POC user. This mapping is illustrated by the following example:

| iDEN | | iDEN Smart |
|---|---|---|
| Subscriber UFMI | POC Contact | Donor Radio UFMI |
| 555*66*434343 | +19626651111 | 555*66*121212 |
| 555*66*434343 | +19626651122 | 555*66*121213 |
| 555*66*434343 | +19626651133 | 555*66*121214 |
| 555*66*434355 | +19626652211 | 555*66*121212 |
| 555*66*434355 | +19626652222 | 555*66*121213 |

In this example, a unique iDEN Smart Donor Radio UFMI is assigned for each POC Contact on an iDEN user's phone. All private calls between these two parties will flow through the assigned Smart Donor Radio Unit 162. To call a POC contact, the iDEN user calls the corresponding iDEN Smart Donor Radio UFMI assigned to that contact.

On the POC System 100, in order to support POC Clients 136 that do not have the capability to dial out iDEN contacts using the iDEN addressing format, each iDEN subscriber is assigned a PseudoMDN. POC subscribers call these PseudoMDN's in order to reach the corresponding iDEN contact. This mapping is illustrated in the below table:

| iDEN subscriber | POC PseudoMDN |
|---|---|
| 555*66*434343 | +19626650801 |
| 555*66*434355 | +19626650802 |
| 555*66*434366 | +19626650803 |
| 555*66*434377 | +19626650804 |

### 5.3.2.1 Methods to Minimize Call Blocking

When ‘K’ Smart Donor Radio Units 162 are deployed in a particular customer premises, it allows each iDEN System 142 subscriber to have ‘K’ POC System 100 users in their contact list. In order to minimize call blocking, the number of contacts pairings that are associated with each iDEN Smart Donor Radio UFMI must be engineered based on the usage model and heuristic analysis of call patterns among the users.

When a POC System 100 user calls an iDEN contact, it is possible that the Smart Donor Radio Unit 162 that is assigned to this particular contact pairing is busy serving a different call. To handle such a situation, a separate reserve pool of Smart Donor Radio Units 162 is used to serve the call. Any one of the idle Smart Donor Radio Units 162 from this reserve pool is used to serve the call when the primary Smart Donor Radio Unit 162 that is assigned to that contact pairing is currently busy. Further, the POC GW System 140 associates a temporary contact pair mapping for the Smart Donor Radio Unit 162 in the reserve pool that is used for handling the call. This temporary mapping is used to route the call back to the correct POC MDN when the iDEN user calls back to the Smart Donor Radio UFMI in the reserve pool.

### 5.1.3 Call Flows

### 5.1.3.1 Overview

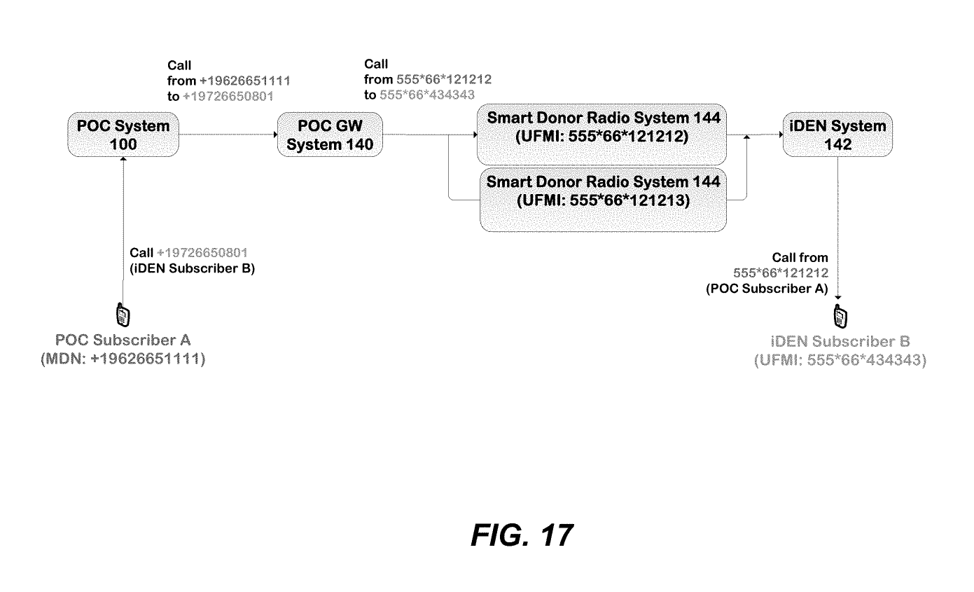

FIG. 17 illustrates a MDN-UFMI mapping using the Smart Donor Radio System 144.

The POC System 100 subscriber calls an iDEN contact using the iDEN UFMI of that contact or the POC PseudoMDN assigned to that iDEN System 142 subscriber. This call is conveyed to the iDEN System 142 via the POC GW System 140, and the corresponding Smart Donor Radio Unit 162 associated with that contact pairing. When the call is made using the PseudoMDN, the POC GW System 140 maps the PseudoMDN to the corresponding iDEN UFMI of the iDEN System 142 subscriber. When this iDEN contact receives the call, the subscriber sees the UFMI assigned to the Smart Donor Radio Unit 162 as the caller ID. This corresponds to the UFMI associated with that POC contact on the iDEN user's phone.

The following table describes how the mappings described in the previous section are used in various call flows:

| No. | Mapping | Description |
|---|---|---|
| 1 | IDEN ID <-> PseudoMDN | PseudoMDN assigned to a IDEN |
| | | subscriber. The PseudoMDN is drawn |
| | | from “IDEN-MDN” pool. |
| 2 | (calling party POC MDN, called party | IDEN Smart Donor Radio to be used as |
| | IDEN UFMI) -> IDEN Smart Donor | calling party for 1-1 call in POC -> IDEN |
| | Radio UFMI | direction |
| 3 | (Calling party IDEN UFMI, called party | The POC MDN corresponding to the |
| | IDEN Smart Donor Radio UFMI) -> | IDEN Smart Donor Radio that has been |
| | called party POC MDN | assigned as contact to the IDEN |
| | | subscriber |

The POC MDN corresponding to the Smart Donor Radio Unit 162 that has been assigned as contact to the IDEN System 142 subscriber

### 5.1.3.2 Private Call

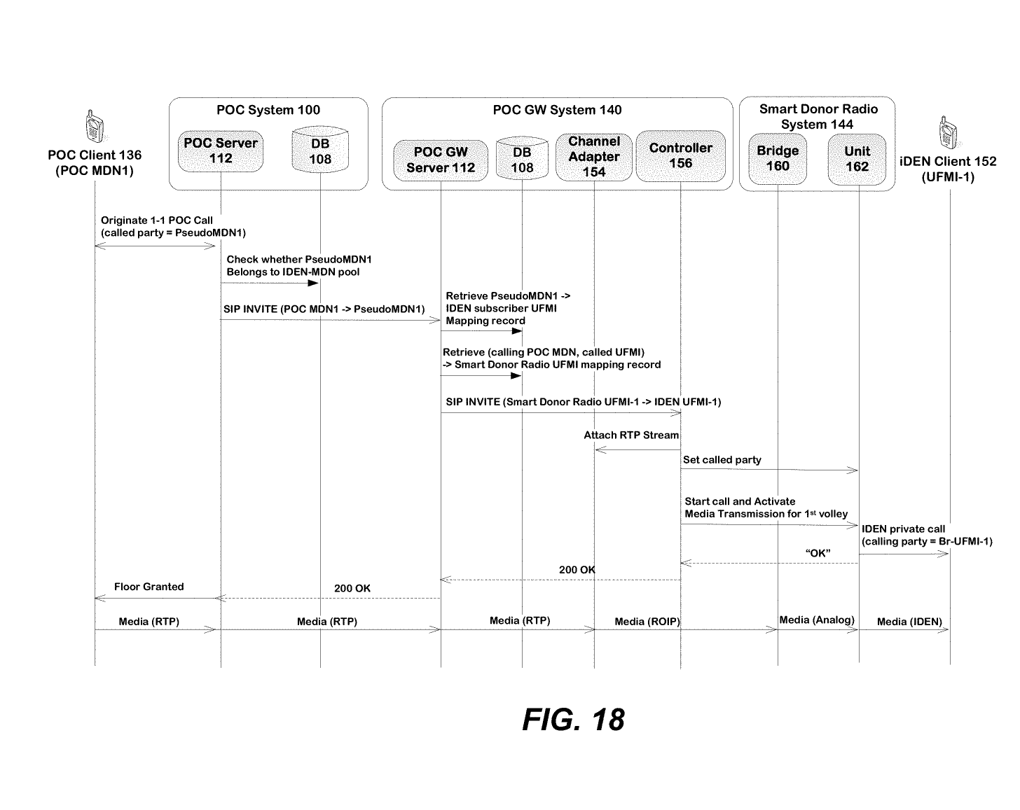

FIG. 18 illustrates a private call using the Smart Donor Radio System 144 from a POC Client 136 to an iDEN Client 152.

It involves the following steps:
1. The POC Client 136 originates a private 1-1 call to a iDEN contact by dialing out the PseudoMDN associated with the iDEN contact. Alternately, the POC Client 136 may directly dial out to the iDEN contact's UFMI.
2. The POC Server 112 receives the call setup request from the POC Client 136 and forwards it the POC GW System 140.
3. The POC GW System 140 maps the called party PseudoMDN to the actual called party iDEN UFMI, identifies the Smart Donor Radio System 144 that is associated with the (calling party MDN, called party UFMI) pair, and sets up a SIP INVITE dialog with the Smart Donor Radio Controller 156 responsible for managing the interface towards that Smart Donor Radio System 144.
4. The Smart Donor Radio Controller 156 attaches the ROIP media stream and the POC GW System 140 media stream to the ROIP Channel Adapter 154. This sets up the media path from the POC GW System 140 to the Smart Donor Radio System 144, and then to the Smart Donor Radio Unit 162 via the Smart Donor Radio Bridge 150 in the customer premises.
5. The Smart Donor Radio Controller 156 sends a command to the Smart Donor Radio System 144 to set the destination iDEN UFMI and then sends a command to initiate an iDEN call towards that UFMI.
6. The Smart Donor Radio Unit 162 places an iDEN call towards the destination UFMI.

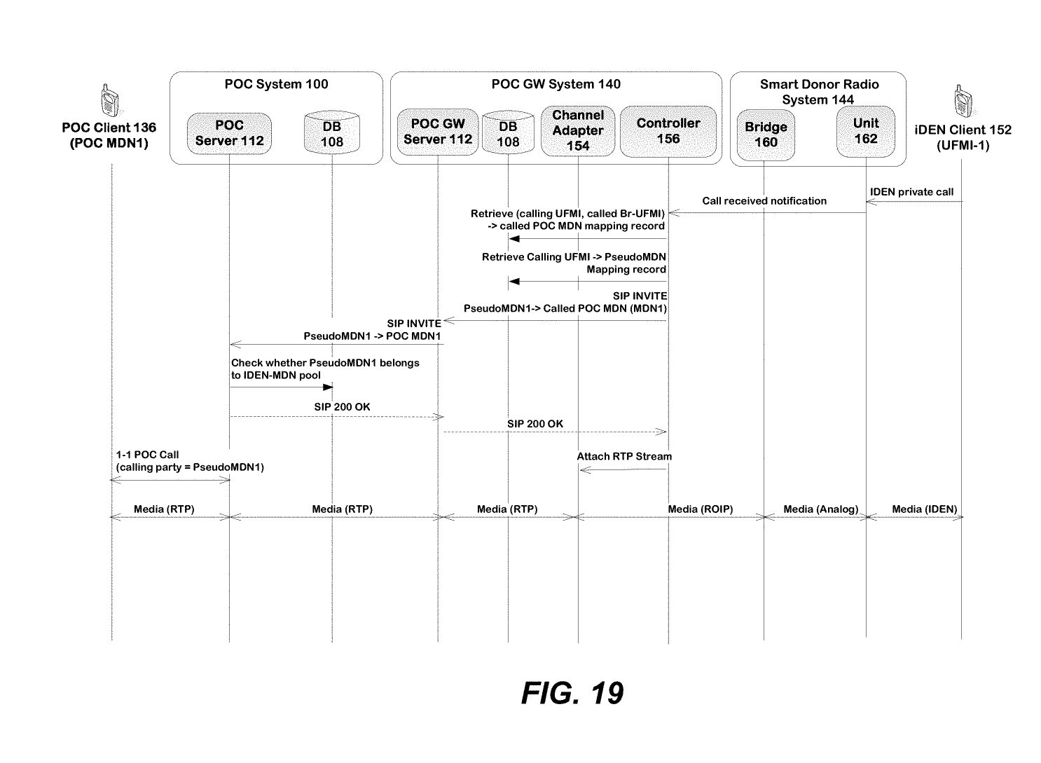

FIG. 19 illustrates a private call through the Smart Donor Radio System 144 from an iDEN Client 152 to a POC Client 136.

It involves the following steps:

1. The iDEN Client 152 originates a private 1-1 call to a POC contact by dialing out the UFMI of the Smart Donor Radio Unit 162 that is associated with the (iDEN UFMI, POC MDN) pair.

2. The Smart Donor Radio Unit 162 receives the call and notifies the Smart Donor Radio Controller 156.

3. The Smart Donor Radio Controller 156 maps the (calling party UFMI, called Smart Donor Radio UFMI) pair to the corresponding POC Client 136 MDN that is being called, and sets up a SIP INVITE dialog towards the POC GW Server 112, which in turn sets up a SIP INVITE dialog with the POC Server 112.

4. Upon successful setup of the SIP INVITE dialog with the POC GW Server 112, the Smart Donor Radio Controller 156 attaches the ROIP media stream and the POC GW System 140 media stream to the ROIP Channel Adapter 154. This sets up the media path from the POC GW System 140 to the Smart Donor Radio Unit 162 via the Smart Donor Radio Bridge 160 in the customer premises.

### 5.3.3.3 Floor Control

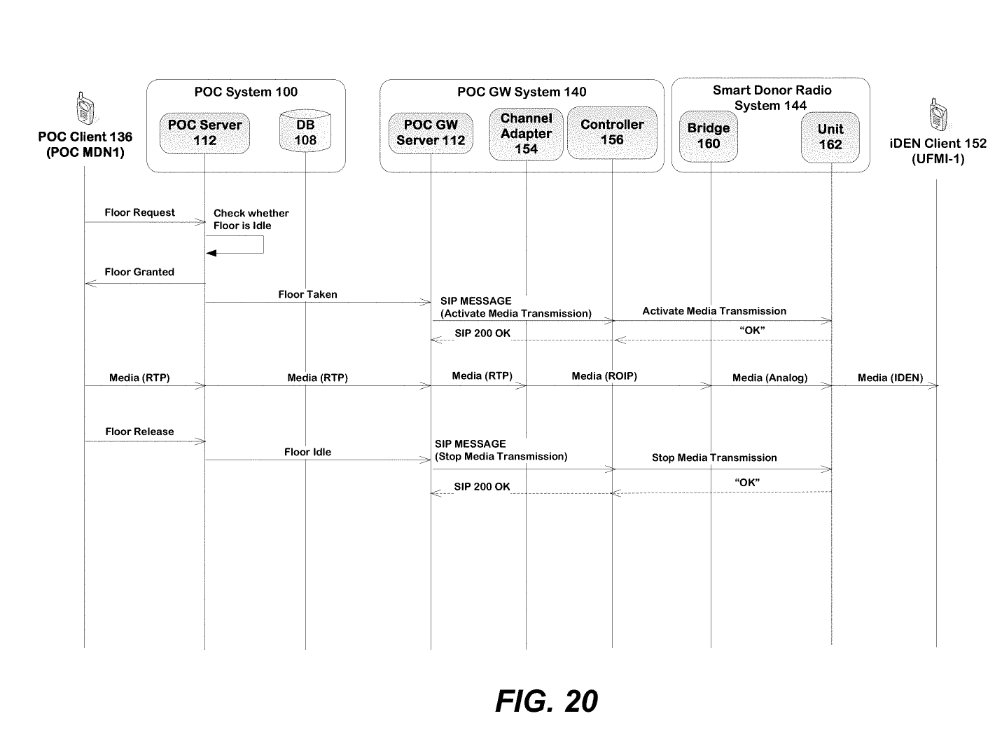

FIG. 20 illustrates a typical floor control exchange sequence through a Smart Donor Radio System 144 during a private call between an iDEN Client 152 and a POC Client 136. The POC Client 136 uses the MCBP protocol for floor control and the Smart Donor Radio Unit 162 exposes a proprietary command interface for floor control. The POC GW System 140 performs the required protocol mapping.

The following steps are involved in the above example flow where a POC Client 136 takes the floor and then releases the floor after transmitting a media burst:

1. When the POC Client 136 initiates a private call towards an iDEN Client 152, the POC System 100 grants the floor initially to the POC Client 136, as it is the call originator, and indicates a floor taken event to the iDEN Client 152.

2. The POC GW System 140 receives the floor taken event from the POC Server 112 and relays it to the Smart Donor Radio Controller 156 using the SIP Message method, which in turn sends the command to the Smart Donor Radio Bridge 160 and the Smart Donor Radio Unit 162 to activate media transmission.

3. The media burst is transmitted by the POC Client 136 to the iDEN Client 152. Along the media path, the media is converted from RTP to ROIP format by the ROIP Channel Adapter 154, following which the Smart Donor Radio Bridge 160 converts the ROIP stream to analog audio, and finally, the Smart Donor Radio Unit 162 picks up this analog audio and transmits it over the air interface of the iDEN System 142.

4. After the media burst transmission is completed, the POC Client 136 releases the floor by sending an MBCP release message.

5. The POC Server 112 changes the floor state to “idle” and transmits the floor idle event to both parties in the call.

6. The POC GW System 140 receive the floor idle event from the POC Server 112 and relays it to the Smart Donor Radio Controller 156 using the SIP MESSAGE method, which in turn sends the command to the Smart Donor Radio Bridge 160 and Smart Donor Radio Unit 162 to stop media transmission.

### 5.1.3.4 Group Call

The group call flow is very similar to the private call flow shown in section 5.3.3.2 above.

Instead of setting the target to an iDEN UFMI, the Smart Donor Radio Controller 156 sends a command to the Smart Donor Radio Bridge 160 and Smart Donor Radio Unit 162 to set the target to an iDEN group ID prior to sending the command to initiate the iDEN call.

Alternately, a Conventional Donor Radio Unit 164 may also be used in conjunction with the Smart Donor Radio Bridge 160 to connect a POC group to an iDEN group.

### 6 Conclusion

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A system for providing communications services in a plurality of wireless networks, comprising:
a gateway system for inter-communicating between a Push-to-Talk-over-Cellular (POC) system in a first wireless network and an Integrated Digital Enhanced Network (iDEN) system in a second wireless network different from the first wireless network;
wherein the POC system provides a POC call session for a plurality of POC mobile units in the first wireless network;
wherein the iDEN system provides a Push-to-Talk (PTT) call session for a plurality of iDEN subscriber units in the second wireless network; and
wherein the gateway system bridges the iDEN system and the POC system, such that the POC system is exposed to the iDEN system as an emulated iDEN system, the iDEN system is exposed to the POC system as an emulated POC system, and calls are placed across the first and second wireless networks between the plurality of POC mobile units and the plurality of iDEN subscriber units.

2. The system of claim 1, wherein the gateway system creates and manages identifier mappings between the plurality of POC mobile units and the plurality of iDEN subscriber units in order to make the plurality of POC mobile units and first groups of the plurality of POC mobile units addressable by the iDEN system, and to make the plurality of iDEN subscriber units and second groups of the plurality of iDEN subscriber units addressable by the POC system.

3. The system of claim 2, wherein the gateway system exposes the plurality of iDEN subscriber units and the second groups to the POC system using mobile unit and group identifiers of the first wireless network, and wherein an iDEN subscriber unit that is exposed to the POC system is assigned a mobile directory number (MDN) in order to make the iDEN subscriber unit addressable by the POC system.

4. The system of claim 2, wherein an iDEN subscriber unit that is exposed to the POC system is addressed by a POC mobile unit in the POC system using a Universal Fleet Member Identifier (UFMI).

5. The system of claim 2, wherein the gateway system exposes the plurality of POC mobile units and the first groups to the iDEN system using subscriber unit and group identifiers of the second wireless network.

6. The system of claim 5, wherein a POC mobile unit that is exposed to the iDEN system is assigned a Universal Fleet Member Identifier (UFMI) in order to make the POC mobile unit addressable by the iDEN system.

7. The system of claim 2, wherein an iDEN Gateway (iGW) is used to interface the gateway system with the iDEN system.

8. The system of claim 7, wherein the gateway system maps an interface with the POC system to the iGW and performs protocol conversions for the iGW.

9. The system of claim 8, wherein the gateway system performs as an iGW when interfacing with the iDEN system.

10. The system of claim 9, wherein the gateway system performs group agglomeration to aggregate group call participants according to the iGW that is currently serving the participants.

11. The system of claim 9, wherein the gateway system discovers the iGW that is currently serving a Universal Fleet Member Identifier (UFMI), and wherein the gateway system discovers the iGW by referencing a mapping of the UFMI to the iGW, setting up a call to the UFMI and caching an address provided in a response from the iGW, sending a call alert event to the iGW and caching an address provided in a response from the iGW, or a combination thereof.

12. The system of claim 2, wherein a POC-iDEN Soft Bridge is used to interface the gateway system with the iDEN system, and wherein the POC-iDEN Soft Bridge comprises:
an iDEN User Agent part; and
a POC User Agent part communicating with the iDEN User Agent part to interface with the iDEN system.

13. The system of claim 12, wherein the POC-iDEN Soft Bridge connects to the iDEN system and the gateway system using an Internet Protocol (IP) interface.

14. The system of claim 12, wherein the gateway system contains a virtual machine pool for a plurality of instances of the POC-iDEN Soft Bridge.

15. The system of claim 14, wherein each instance of the POC-iDEN Soft Bridge is associated with a Universal Fleet Member Identifier (UFMI), and wherein a POC mobile unit in the POC system that communicates with the iDEN system associated with an instance of the POC-iDEN Soft Bridge is addressed using a UFMI corresponding to the instance of the POC-iDEN Soft Bridge.

16. The system of claim 15, wherein a mobile directory number (MDN) is assigned to an instance of the POC-iDEN Soft Bridge, wherein the MDN is included in a POC group, and wherein the POC group is associated with an iDEN group by including the UFMI of the instance of the POC-iDEN Soft Bridge in the iDEN group.

17. The system of claim 16, wherein in response to the instance of the POC-iDEN Soft Bridge receiving a group call leg from the POC system corresponding to the MDN assigned to the instance of the POC-iDEN Soft Bridge, the instance of the POC-iDEN Soft Bridge initiates a group call to the iDEN group on the iDEN system.

18. The system of claim 16, wherein in response to the instance of the POC-iDEN Soft Bridge receiving a group call leg from the iDEN system corresponding to the UFMI associated with the instance of the POC-iDEN Soft Bridge, the instance of the POC-iDEN Soft Bridge triggers a group call to the POC group on the POC System.

19. The system of claim 12, wherein the POC-iDEN Soft Bridge receives an audio transmission from the POC system via the POC User Agent part and relays the audio transmission to the iDEN system via the iDEN User Agent part, and wherein the POC-iDEN Soft Bridge receives an audio transmission from the iDEN system via the iDEN User Agent part and relays the audio transmission to the POC system via the POC User Agent part.

20. The system of claim 12, wherein the POC-iDEN Soft Bridge intercepts output signals from the iDEN User Agent part, interprets the output signals to determine signaling information pertaining to PTT call setup and PTT floor control, and relays the signaling information to the POC system via the POC User Agent part.

21. The system of claim 12, wherein the POC-iDEN Soft Bridge receives signaling information pertaining to PTT call setup and PTT floor control from the POC system via the POC User Agent part and relays the signaling information to the iDEN system via the iDEN User Agent part.

22. The system of claim 2, wherein a smart donor radio unit is used to interface the gateway system with the iDEN system, and wherein the smart donor radio unit is programmatically controlled through an Internet Protocol (IP) based interface.

23. The system of claim 22, wherein the smart donor radio unit connects to the iDEN system over an air interface and provides the IP based interface to the gateway system.

24. The system of claim 22, wherein the smart donor radio unit receives audio from the iDEN system during PTT calls and transmits the audio in analog format to a smart donor radio bridge.

25. The system of claim 24, wherein the smart donor radio bridge receives the audio in an analog format and transmits the audio in a digital format to the gateway system over the IP based interface, and wherein the digital format is in accordance with a Radio Over IP (ROIP) protocol.

26. The system of claim 24, wherein the smart donor radio bridge receives the audio in a digital format over the IP based interface from the gateway system during PTT calls and transmits the audio in an analog format to the smart donor radio unit, and wherein the digital format is in accordance with a Radio Over IP (ROIP) protocol.

27. The system of claim 24, wherein the smart donor radio unit receives the audio in an analog format from the smart donor radio bridge and transmits the audio in the analog format to the iDEN system over an air interface.

28. The system of claim 22, wherein the gateway system uses the IP based interface to control PTT call signaling and PTT floor control.

29. The system of claim 28, wherein the IP based interface includes commands to set a destination Universal Fleet Member Identifier (UFMI), set a destination group identifier, initiate a call, terminate call, request a PTT floor, release a PTT floor, query a device state, or a combination thereof.

30. The system of claim 22, wherein the smart donor radio unit sends a notification message to the gateway system through the IP based interface, and wherein the notification message comprises a new private call notification, new group call notification, PTT floor granted notification, PTT floor busy notification, PTT floor idle notification, PTT floor request denied notification, private call termination, group call termination notification, calling party identification information, current talker identification information, or a combination thereof.

31. The system claim 22, wherein the smart donor radio unit is associated with a Universal Fleet Member Identifier (UFMI).

32. The system of claim 31, wherein the gateway system associates the smart donor radio unit to a contact pair comprised of a user from the POC system and a user from the iDEN system, wherein the user from the POC system in the contact pair is addressed by the user in the iDEN system in the contact pair using the UFMI associated with the smart donor radio unit associated with the contact pair.

33. The system of claim 32, wherein the smart donor radio unit associated with the contact pair is used when the user in the POC system of the contact pair makes a private call to the user in the iDEN system of the contact pair, and wherein wherein the smart donor radio unit associated with the contact pair is used when the user in the iDEN system of the contact pair makes a private call to the user in the POC system of the contact pair.

34. The system of claim 32, wherein the smart donor radio unit associated with the contact pair is used when the user in the POC system of the contact pair sends a call alert to the user in the iDEN system of the contact pair, and wherein the smart donor radio unit associated with the contact pair is used when the user in the iDEN system of the contact pair sends a call alert to the user in the POC system of the contact pair.

35. The system of claim 32, wherein the smart donor radio unit is associated with a plurality of contact pairs, and wherein a different smart donor radio unit which is currently not busy in a call is used to handle a call between the contact pair when the smart donor radio unit that is associated with the contact pair is busy serving another call between a different contact pair.

36. The system of claim 35, wherein gateway system creates a temporary association between the different smart donor radio unit and the contact pair when the different smart donor radio unit is used to handle the call between the contact pair that is not already associated with the different smart donor radio unit.

37. The system of claim 36, wherein the gateway system uses the temporary association between the different smart donor radio unit and the contact pair to identify the user in the POC system when the user in the iDEN system in the contact pair makes a call to the UFMI of the smart donor radio unit to which the contact pair has the temporary association.

38. The system of claim 36, wherein the temporary association between the different smart donor radio unit and the contact pair is overwritten by a new temporary association with a different contact pair, the new temporary association contains a same user in the iDEN system as in a previous contact pair and a different user in the POC system when a call from the different user in the POC system is towards the same user in the iDEN system served through the different smart donor radio unit.

39. The system of claim 31, wherein the gateway system associates a group in the POC system with a smart donor radio unit and the group in the POC system is associated with a group in the iDEN system by including the UFMI of the smart donor radio unit in the group in the iDEN system.

40. The system of claim 39, wherein the gateway system receives a group call leg from the POC system when the group in the POC system is associated with a smart donor radio unit and the gateway system causes the smart donor radio unit to initiate a group call to a corresponding group in the iDEN system.

41. The system of claim 39, wherein the smart donor radio unit receives a group call from the iDEN system and notifies the gateway system that the group call was received, and wherein the gateway system receives a notification that the group call was received from the smart donor radio unit and triggers a group call to a corresponding group in the POC System.

42. A method for providing communications services in a plurality of wireless networks, comprising:
inter-communicating, by a gateway system, between a Push-to-Talk-over-Cellular (POC) system in a first wireless network and a Integrated Digital Enhanced Network (iDEN) system in a second wireless network;
wherein the POC system provides a POC call session for a plurality of POC mobile units in the first wireless network;
wherein the iDEN system provides a Push-to-Talk (PTT) call session for a plurality of iDEN subscriber units in the second wireless network; and
wherein the gateway system bridges the iDEN system to the POC system, such that the POC system is exposed to the iDEN system as an emulated iDEN system, the iDEN system is exposed to the POC system as an emulated POC system, and calls are placed across the first and second wireless networks between the POC mobile units and iDEN subscriber units.
